(19) United States
(12) Patent Application Publication
(10) Pub. No.: US 2025/0101149 A1
(43) Pub. Date: Mar. 27, 2025

(54) Processes for Making Propylene-Based Copolymers Having Broad CDs and MWDs

(71) Applicant: Exxonmobil Technology and Engineering Company, Baytown, TX (US)

(72) Inventors: Stacy Jordahl, Webster, TX (US); Jun Shi, Houston, TX (US); Rong Ma, Houston, TX (US); Antonios K. Doufas, Houston, TX (US); Narayanaswami Dharmarajan, Houston, TX (US)

(21) Appl. No.: 18/717,135

(22) PCT Filed: Dec. 14, 2022
(86) PCT No.: PCT/US2022/081509

§ 371 Date: Jun. 6, 2024

Related U.S. Application Data
(60) Provisional application No. 63/290,874, filed on Dec. 17, 2021.

(51) Int. Cl. C08F 10/06

(52) U.S. Cl. CPC C08F 10/06

(57) ABSTRACT

Processes for making propylene-based copolymers having broad molecular weight distributions and broad comonomer distributions using a single tubular reactor. Processes for making a propylene-based copolymer can include introducing propylene and at least one other olefin comonomer to a tubular reactor to produce a propylene-based copolymer having a broad comonomer distribution, a Mw of about 10 kg/mol to about 2.000 kg/mol, and a MWD of about 2.0 to about 10.0. The tubular reactor can include one or more heat exchanger elements, preferably a spiral heat exchanger. Propylene-based copolymer compositions can include propylene derived units and at least one other comonomer derived units, wherein the copolymer compositions have a broad comonomer distribution, a Mw of about 10 kg/mol to about 2.000 kg/mol, and a MWD of about 2.0 to about 10.0. Such compositions can have broad orthogonal comonomer distributions.

### CROSS-REFERENCE TO RELATED APPLICATIONS

This application claims the benefit of U.S. Provisional Application No. 63/290,874, filed on Dec. 17, 2021, the entire contents of which are incorporated herein by reference FIELD

Embodiments of the present invention generally relate to processes for making propylene-based copolymers and copolymer compositions made by same. More particularly, such embodiments relate to processes for making propylene-based copolymers having broad comonomer distributions and broad molecular weight distributions using a tubular reactor.

### BACKGROUND

Propylene-based copolymers are in high demand due to their high flexibility, toughness, clarity, and processability. Such copolymers have a wide range of applications, including blown and cast films, injection molded containers and other goods, and nonwoven fabrics. Both high-viscosity and low-viscosity propylene-based copolymers have been produced.

One type of catalyst system that can be used to produce propylene-based copolymers is a metallocene-based catalyst system. Metallocene catalysts are homogenous single site catalysts that include organometallic coordination compounds in which one or two cyclopentadienyl rings or substituted cyclopentadienyl rings are π-bonded to a central transition metal atom. Metallocene catalysts typically produce propylene-based copolymers with a narrow molecular weight distribution and a uniform distribution of comonomer across the population of polymer chains. This is in contrast to a broad molecular weight distribution and a broad comonomer distribution (BCD), especially a broad and orthogonal comonomer distribution (BOCD).

While a polymer having a narrow molecular weight distribution and a uniform comonomer distribution can be advantageous for certain processes and end-use applications, this type of polymer can be undesirable for others. For example, a narrow molecular weight distribution polymer may require the use of a fluoropolymer additive in order to process the polymer at desirable production rates without flow instabilities, such as melt fracture. Unfortunately, the use of a fluoropolymer processing aid increases the cost of producing a finished article from the polymer. Stability in other polymer processing operations, such as blown film and blow molding, often is reduced with a narrow molecular weight distribution polymer, as compared to a broader molecular weight distribution polymer, resulting in reduced production rates. Also, polymers having a uniform comonomer distribution as compared to polymers having a non-uniform BCD often fail to have a good balance of mechanical properties such as strength, stiffness, tear resistance, and impact resistance. Such polymers can also have problems with pellet stability, crosslinking efficiency, and elastic recovery. Having the ability to control the molecular weight distributions and the comonomer distributions of polymers produced using a metallocene-based catalyst is therefore highly desirable.

Other catalysts, such as chromium or Ziegler-Natta (ZN) type catalysts, can be used to produce broader molecular weight distribution propylene-based polymers. However, when either a chromium or a ZN catalyst is employed, the resultant comonomer distribution is rarely, if ever, BOCD. Also, the use of hydrogen in the polymerization process can cause a narrowing of the molecular weight distribution of the resulting polymers. Thus, using such catalysts limit the ability to control the extent of the molecular weight distribution of the resulting polymers. The use of ZN catalysts also undesirably tends to produce polymers with many oligomers and low molecular weight ends that can be detrimental to the mechanical properties of the polymers. Also, peroxide is often required to break such polymers when it is desirable to use the polymers in fiber and nonwoven applications.

To overcome the challenges involved in using chromium or ZN catalysts, mixed metallocene-based catalyst systems containing multiple metallocene catalysts have been developed that can be used to control the molecular weight distribution of the polymer. Ways have also been developed to control the molecular weight distribution using two or more continuous stirred-tank reactors (CSTRs) with a metallocene-based catalyst system. These options do not provide for efficient control of molecular weight distribution and comonomer distribution at the same time. One disadvantage of using multiple CSTRs is the cost required to construct multiple reactors. Also, using multiple CSTRs still does not achieve as broad a MWD as desired. The use of multiple CSTRs presents greater operational complexity than just operating one reactor. Moreover, two CSTRs are likely to result in bimodal distributions from the combination of two discrete fractions, rather than a continuous spectrum of comonomer contents. The comonomer distribution from an individual CSTR most likely will be uniform, so the multi-CSTR approach likely results in linear combination of uniform distributions to simulate a broad distribution. This is in contrast to a smooth continuum across a broad distribution. The other option of using multiple types of catalyst can be more expensive and more complex than using a single type of catalyst. This option can entail the difficulty of having to identify and/or develop new catalyst molecules that are capable of being combined and when combined, result in the specific desired product.

A need therefore exists for a way to inexpensively produce propylene-based copolymers using a metallocene-based catalyst and a solution polymerization process. It would also be desirable to produce propylene-based copolymers having a good balance of properties, allowing the copolymers to be used in a wide variety of applications. Also, it would be beneficial to have the ability to produce propylene-based copolymers having broad molecular weight distributions and comonomer distributions, especially when the comonomer distribution is BOCD.

### SUMMARY

Processes for making propylene-based copolymers having broad comonomer distributions and broad molecular weight distributions using a tubular reactor are provided. In one or more embodiments, a process for making a propylene-based copolymer can include introducing propylene and at least one other olefin comonomer to a tubular reactor to produce a propylene-based copolymer having a broad comonomer distribution, a Mw of about 10 kg/mol to about 2,000 kg/mol, and a MWD of about 2.0 to about 10.0. The tubular reactor can include a recycle pump and/or one or more heat exchanger elements, preferably a spiral heat exchanger.

In one or more embodiments, a propylene-based copolymer composition can include propylene derived units and at least one other comonomer derived units, the copolymer composition having a broad comonomer distribution, a Mw of about 10 kg/mol to about 2,000 kg/mol, and a MWD of about 2.0 to about 10.0. This copolymer composition can also have a broad orthogonal comonomer distribution.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1a depicts a tubular reactor containing a spiral heat exchanger oriented in a substantially vertical direction, according to one or more embodiments provided herein.

FIG. 1b depicts a top view of the spiral heat exchanger in FIG. 1a.

FIG. 2 depicts a tubular reactor containing a spiral heat exchanger oriented in a substantially horizontal direction, according to one or more embodiments provided herein.

FIG. 3 is a graph depicting the molecular weight distribution versus recycle ratio of propylene-ethylene copolymers produced according to one or more embodiments provided herein.

FIG. 4 is a graph depicting the ethylene content distribution across the log scale of the molecular weight for the propylene-ethylene copolymers of FIG. 3.

FIG. 5 is a graph depicting the ethylene content distribution across the log scale of the molecular weight for propylene-ethylene copolymers produced by a conventional process.

FIG. 6 is a graph depicting the molecular weight distribution and the ethylene content distribution for lower viscosity propylene-ethylene copolymers produced according to one or more embodiments provided herein.

FIG. 7 is a graph depicting the molecular weight distribution and the ethylene content distribution for propylene-ethylene copolymers produced according to one or more embodiments provided herein.

FIG. 8 is a graph depicting the breadths of comonomer incorporation and monomer sequence length distribution determined by Solvent Gradient Interactive Chromatography for propylene-ethylene copolymers produced according to one or more embodiments provided herein.

FIG. 9 is a graph depicting the molecular weight distribution and the ethylene content distribution for propylene-ethylene copolymers produced using different recycle ratios, according to one or more embodiments provided herein.

FIG. 10 is a graph depicting the molecular weight distribution and the ethylene content distribution for lower viscosity propylene-ethylene copolymers produced according to one or more embodiments provided herein.

FIG. 11 is graph depicting the molecular weight distribution and the ethylene content distribution for propylene-ethylene copolymers produced according to one or more embodiments provided herein.

FIG. 12 is graph depicting the molecular weight distribution and the ethylene content distribution for propylene-ethylene copolymers produced using a Ziegler-Natta catalyst.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

In the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case does not include any other component to a level greater than 3 mass %.

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

The term “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

The term “polymer” refers to any two or more of the same or different repeating units/mer units or units. The term “homopolymer” refers to a polymer having units that are the same. The term “copolymer” refers to a polymer having two or more units that are different from each other, and includes terpolymers and the like. The term “terpolymer” refers to a polymer having three units that are different from each other. The term “different” as it refers to units indicates that the units differ from each other by at least one atom or are different isomerically. Likewise, the definition of polymer, as used herein, includes homopolymers, copolymers, and the like. By way of example, when a copolymer is said to have a “propylene” content of 10 wt % to 30 wt %, it is understood that the repeating unit/mer unit or simply unit in the copolymer is derived from propylene in the polymerization reaction and the derived units are present at 10 wt % to 30 wt %, based on a weight of the copolymer.

The term “continuous” refers to a system that operates without interruption or cessation. For example, a continuous process to produce a polymer would be one where the reactants are continually introduced into one or more reactors and polymer product is continually withdrawn.

The term “solution polymerization” refers to a polymerization process in which the polymer is dissolved in a liquid polymerization medium, such as an inert solvent, monomer(s), or blends thereof. A solution polymerization is typically homogeneous. The term “homogeneous polymerization” refers to a polymerization process where the polymer product is dissolved in the polymerization medium. Such systems are preferably not turbid as described in J. Vladimir Oliveira, C. Dariva, and J. C. Pinto, Ind. Eng. Chem. Res., 29, 2000, 4627. A homogeneous polymerization process is typically a process where at least 90 wt % of the product is soluble in the reaction media.

The term “laminar” flow refers to flow of a fluid (e.g., gas, liquid) in parallel layers without disruption between the layers. Fluids may exhibit laminar flow near a solid boundary. “Near-laminar” flow refers to flow of a fluid in parallel layers with minimal disruption between the layers.

As used herein, “Mn” refers to the number average molecular weight of the different polymers in a polymeric material, “Mw” refers to the weight average molecular weight of the different polymers in a polymeric material, and “Mz” refers to the z average molecular weight of the different polymers in a polymeric material. The terms “molecular weight distribution” (MWD) and “polydispersity index” (PDI) are used interchangeably to refer to the ratio of Mw to Mn. Also, the term “broad comonomer distribution” (BCD) refers to a non-uniform comonomer distribution, where a “uniform distribution” is said to have all CD slope values between-1 and 1. The term “broad orthogonal comonomer distribution” (BOCD) refers to a positively sloped comonomer distribution, where the comonomer content increases with increasing log of the molecular weight of a polymer. BOCD polymers have at least one CD slope of 1.5 or greater.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6th Edition, by F. Albert Cotton et al. (John Wiley & Sons, Inc., 1999).

A detailed description will now be provided. Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions, and examples, but the inventions are not limited to these embodiments, versions, or examples, which are included to enable a person having ordinary skill in the art to make and use the inventions when the information in this disclosure is combined with publicly available information and technology.

Processes for making propylene-based copolymers are disclosed herein that can include introducing propylene and at least one other olefin comonomer to a single tubular reactor to produce both high-viscosity and low-viscosity propylene-based copolymers that include propylene derived units and at least one other comonomer derived units. The term “tubular reactor” refers to a reactor into which feed is continuously introduced (e.g., via an inlet) and from which product is continuously removed (e.g., via an outlet), wherein stirring typically does not occur within the reactor. For example, the tubular reactor can be substantially tubular shaped, and can include a straight pipe or a loop to enable recycle. The tubular reactor may include one or more plug flow components and/or one or more lamellar flow elements. The tubular reactor can include a recycle pump. Preferably, the tubular reactor can include one or more heat exchangers. The heat exchanger(s) can be a spiral heat exchanger (SHE). The polymerization process may include other polymerization reactors in addition to the tubular reactor.

The polymerization reaction within the tubular reactor is preferably performed using a single type of catalyst, i.e., a catalyst that is not mixed or blended with any other catalysts within the tubular reactor. This single type of catalyst can be a single-site catalyst, for example, a metallocene catalyst, a half-metallocene catalyst, or a post-metallocene catalyst. Other reactors in the polymerization process can include another type of catalyst.

Shifting from a conventional CSTR to a tubular reactor can introduce inhomogeneity along the axis of the fluid flow direction as well as along the radial direction across each tube within the reactor. Harnessing this inhomogeneity through temperature and concentration gradients, and controlling the degree of inhomogeneity through recycle ratio (RR) can vastly expand the product design space accessible using a single reactor and a single type of metallocene catalyst. Multi-reactor or multi-catalyst operation can also be employed when a greater degree of structural complexity is desired in the final polymer product. Utilizing a tubular reactor with recycle can enhance product design capabilities and tunability of the product for superior performance in the application of interest. Using a tubular reactor also provides for smooth continuum of comonomer contents across a broad distribution.

Surprisingly, propylene-based copolymer compositions having a broad comonomer distribution (BCD), a Mw ranging from about 10 to about 2,000 kg/mol, and a broad MWD ranging from about 2.0 to about 10.0, as determined by Gel Permeation Chromatography (GPC), can be produced using the processes disclosed herein, even in the presence of hydrogen. A polymer having a broad comonomer distribution can have either a relatively high molecular weight chain with lower comonomer incorporation or a relatively low molecular weight chain with higher comonomer incorporation. The comonomer compositions disclosed herein can also have a broad orthogonal comonomer distribution (BOCD) that preferably has a comonomer distribution (CD) slope 20 to 80 of about 1.5 to about 30.0. Details regarding how to determine CD slopes are provided in the Test Procedures below. As described previously, olefin copolymers having these properties usually cannot be produced using only one metallocene-based catalyst and one CSTR. Thus, the processes disclosed herein are not only simpler and more cost effective than other processes, but they also provide for a higher level of control of the MWD and the comonomer distribution. It also has been unexpectedly discovered that the MWDs of the propylene-based copolymers can be increased by decreasing the recycle ratio of the SHE reactor(s). Additionally, the copolymer compositions can have propylene-based crystallinity with a heat of fusion that can range from a low of about 0.5, 5.0, or 10.0 to a high of about 60.0, 70.0, or 75.0 J/g, as measured using differential scanning calorimetry (DSC). The copolymer compositions also can exhibit a melt flow rate (MFR) of about 0.1 to about 1,000 g/10 min, according to ASTM D1238 (2.16 kg, 230° C.), or a Brookfield viscosity (BV) of about 400 to 50,000 cP, according to ASTM D1238 (190° C.).

The propylene-based copolymer compositions can exhibit an improved balance of mechanical properties such as strength, stiffness, tear resistance, and impact resistance. They can also have improved pellet stability, crosslinking efficiency, and compatibility with other polymers such as polypropylene (PP) homopolymers. As a result of the outstanding crosslinking efficiency of the propylene-based copolymer compositions, these compositions can be employed in applications such as wires and cables as well as photovoltaic cells. Due to their excellent balance of mechanical properties, the copolymer compositions can also be used in a wide variety of applications such as elastic nonwoven fabrics (e.g., for hygiene purposes), elastic films and laminates, plastic tubing (e.g., medical tubing), and plastic bags (e.g., medical IV bags). Since the propylene-based copolymers disclosed herein are very compatible with other polymers, they can be blended with homopolymers, such as PP homopolymer, as well as with other copolymers to form polymer blend compositions.

### Polymerization Process

The polymerization process can be a solution polymerization process in which the monomer, the comonomer, and the catalyst system are contacted in a solution phase and polymer is formed therein. Preferably, the process conditions are sufficient to keep the polymer in solution phase, and the solution phase is preferably a single phase. A solvent can be present during the polymerization process. Suitable solvents for the polymerization process can include non-coordinating, inert liquids. Examples include straight and branched-chain hydrocarbons, such as isobutane, butane, pentane, isopentane, hexane, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as Isopar™ commercially available from ExxonMobil; perhalogenated hydrocarbons, such as perfluorinated alkanes, and chlorobenzene; and aromatic and alkylsubstituted aromatic compounds, such as benzene, toluene, mesitylene, and xylene. In a preferred embodiment, the feed concentration of the monomer and comonomer for the polymerization is 60 vol % or less, preferably 40 vol % or less, or more preferably 20 vol % or less, based on the total volume of the feedstream.

### The Monomer and Comonomer

As described previously, the monomer can be propylene (C3). The at least one other olefin comonomer can be or can include ethylene (C2), a substituted or unsubstituted C4 to C40 olefin (preferably a C4 to C20 olefin), or combinations thereof, with C2 being most preferred. Such C4 to C40 olefin comonomers can be linear, branched, or cyclic. Suitable C4 to C40 cyclic olefins can be strained or unstrained, monocyclic or polycyclic, and can optionally include heteroatoms and/or one or more functional groups. The reactor C3 concentration can range from 0.1 to 30.0 wt %, and the reactor comonomer concentration can range from 0.1 to 30.0 wt %.

Specific examples of suitable C4 to C20 comonomers include butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, preferably norbornene, norbornadiene, and dicyclopentadiene.

In a preferred embodiment, one or more dienes (diolefin monomer) are added to the polymerization process. The diene can be present in the polymer produced herein at up to 10 wt %, preferably at 0.00001 to 8.0 wt %, preferably 0.002 to 8.0 wt %, even more preferably 0.003 to 8.0 wt %, based upon the total weight of the composition. In some embodiments, 500 ppm or less of diene is added to the polymerization, preferably 400 ppm or less, preferably 300 ppm or less. In other embodiments, at least 50 ppm of diene is added to the polymerization, or 100 ppm or more, or 150 ppm or more.

Suitable diolefin monomers include any hydrocarbon structure, preferably C4 to C30, having at least two unsaturated bonds, where at least one of the unsaturated bonds are readily incorporated into a polymer chain during chain growth. It is further preferred that the diolefin monomers be selected from alpha, omega-diene monomers (i.e., di-vinyl monomers). More preferably, the diolefin monomers are linear di-vinyl monomers, most preferably those containing from 4 to 30 carbon atoms. Specific examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, 5-vinyl-2-norbornene, norbornadiene, 5-ethylidene-2-norbornene, divinylbenzene, and dicyclopentadiene or higher ring containing diolefins with or without substituents at various ring positions.

### Catalyst System

The catalyst system used for the polymerization process described herein can include a bulky ligand transition metal catalyst known as a “metallocene catalyst: or a “metallocene catalyst precursor”. The bulky ligand can contain a multiplicity of bonded atoms, preferably carbon atoms, forming a group, which may be cyclic with one or more optional hetero-atoms. The bulky ligand can be a metallocene-type cyclopentadienyl derivative, which can be mono- or poly-nuclear. One or more bulky ligands can be bonded to the transition metal atom. The bulky ligand is assumed, according to prevailing scientific theory, to remain in position in the course of polymerization to provide a homogenous polymerization effect. Other ligands can be bonded or coordinated to the transition metal, preferably detachable by a cocatalyst or activator, such as a hydrocarbyl or halogen-leaving group. It is assumed that detachment of any such ligand leads to the creation of a coordination site at which the olefin monomer can be inserted into the polymer chain. The transition metal atom can be a Group IV, V or VI transition metal of the Periodic Table of Elements. The transition metal atom is preferably a Group IVB atom.

The metallocene catalyst precursor generally requires activation with a suitable co-catalyst (sometimes referred to as an activator) in order to yield an active metallocene catalyst, i.e., an organometallic complex with a vacant coordination site that can coordinate, insert, and polymerize olefins.

The term “catalyst system” means a catalyst precursor/activator pair. When “catalyst system” is used to describe such a pair before activation, it means the unactivated catalyst (pre-catalyst) together with an activator and, optionally, a co-activator. When it is used to describe such a pair after activation, it means the activated catalyst and the activator or other charge-balancing moiety. The transition metal compound may be neutral as in a pre-catalyst, or a charged species with a counter ion as in an activated catalyst system. The term “catalyst system” can also include more than one catalyst precursor and/or more than one activator and optionally a co-activator.

Catalyst precursor is also often referred to as pre-catalyst, catalyst, catalyst compound, transition (or lanthanide or actinide) metal compound or transition (or lanthanide or actinide) metal complex. These words are used interchangeably. Activator and co-catalyst (or co-catalyst) are also used interchangeably. A scavenger is a compound that is typically added to facilitate polymerization by scavenging impurities. Some scavengers may also act as activators and may be referred to as co-activators. A co-activator that is not a scavenger may also be used in conjunction with an activator in order to form an active catalyst. In some embodiments, a co-activator can be pre-mixed with the transition metal compound to form an alkylated transition metal compound.

An activator or co-catalyst is a compound or mixture of compounds capable of activating a pre-catalyst to form an activated catalyst. The activator can be a neutral compound (also called a neutral activator) such as tris-perfluorphenyl boron or tris-perfluorophenyl aluminum, or an ionic compound (also called a discrete ionic activator) such as dimethylanilinium tetrakis-perfluorophenyl borate or triphenylcarbonium tetrakis-perfluoronaphthyl borate. Activators of these types are also commonly referred to as non-coordinating anion activators (NCA activators) owing to the commonly held belief by those skilled in the art, that the reaction of the activator with the pre-catalyst forms a cationic metal complex and an anionic non-coordinating or weekly coordinating anion (NCA). Activators of these types that are discrete characterizable compounds by definition exclude alumoxane co-catalysts which are mixtures. The use of the term NCA is used as an adjective to describe the type of activator as in an NCA activator, or is used as a noun to describe the non-coordinating or weakly coordinating anion which is derived from the NCA activator.

The processes described herein may use any catalyst system capable of polymerizing the monomers disclosed herein if that catalyst system is sufficiently active under the polymerization conditions disclosed herein. Thus, group 3-10 transition metal compounds or lanthanide metal compounds or actinide metal compounds may form suitable catalysts. A suitable olefin polymerization catalyst should be able to coordinate to, or otherwise associate with, an alkenyl unsaturation. Exemplary, but not limiting, catalysts include metallocene catalyst compounds.

Preferably, the catalyst is used in a cationic state and stabilized by a co-catalyst or activator. Especially preferred are group 4 metallocenes of (i.e., titanium, hafnium or zirconium) which typically exist during the polymerization in the d° mono-valent cationic state and bear one or two ancillary ligands. The important features of such catalysts for coordination polymerization is that the pre-catalyst comprises a ligand capable of abstraction and another ligand into which ethylene (or other olefin) can be inserted.

Representative metallocene-type compounds useful herein are represented by the formula:

TⱼL^{A}L^{B}Lᵢ^{C}MDE

where, M is a group 3, 4, 5, or 6 transition metal atom, or a lanthanide metal atom, or actinide metal atom, preferably a group 4 transition metal atom selected from titanium, zirconium or hafnium; L^{A}, an ancillary ligand, is a substituted or unsubstituted monocyclic or polycyclic arenyl pi-bonded to M; L^{B} is a member of the class of ancillary ligands defined for L^{A}, or is J, a hetero-atom ancillary ligand bonded to M through the heteroatom; the L^{A} and L^{B} ligands may be covalently bridged together through a bridging group, T, containing a group 14, 15 or 16 element or boron wherein j is 1 if T is present and j is 0 if T is absent (j equals 0 or 1); Lᵢ^{C} is an optional neutral, non-oxidizing ligand having a dative bond to M (i equals 0, 1, 2 or 3); and, D and E are independently mono-anionic labile ligands, each having a sigma-bond to M, optionally bridged to each other or to L^{A}, L^{B} or L^{C}.

As used herein, the term “monocyclic arenyl ligand” is used herein to mean a substituted or unsubstituted monoanionic C₅ to C₁₀₀ hydrocarbyl ligand that contains an aromatic five-membered single hydrocarbyl ring structure (also referred to as a cyclopentadienyl ring).

As used herein, the term “polycyclic arenyl ligand” is used herein to mean a substituted or unsubstituted monoanionic C₈ to C₁₀₃ hydrocarbyl ligand that contains an aromatic five-membered hydrocarbyl ring (also referred to as a cyclopentadienyl ring) that is fused to one or two partially unsaturated, or aromatic hydrocarbyl or heteroatom substituted hydrocarbyl ring structures which may be fused to additional saturated, partially unsaturated, or aromatic hydrocarbyl or heteroatom substituted hydrocarbyl rings.

Cyclopentadienyl ligands, indenyl ligands fluorenyl ligands, tetrahydroindenyl ligands, cyclopenta[b]thienyl ligands, and cyclopenta[b]pyridyl ligands are all examples of arenyl ligands.

Non-limiting examples of L^{A} include substituted or unsubstituted cyclopentadienyl ligands, indenyl ligands, fluorenyl ligands, dibenzo[b,h]fluorenyl ligands, benzo[b]fluorenyl ligands, azulenyl ligands, pentalenyl ligands, cyclopenta[b]naphthyl ligands, cyclopenta[a]naphthyl ligands, cyclopenta[b]thienyl ligands, cyclopenta[c]thienyl ligands, cyclopenta[b]pyrrolyl ligands, cyclopenta[c]pyrrolyl ligands, cyclopenta[b]furyl ligands, cyclopenta[c]furyl ligands, cyclopenta[b]phospholyl ligands, cyclopenta[c]phospholyl ligands, cyclopenta[b]pyridyl ligands, cyclopenta[c]pyridyl ligands, cyclopenta[c]phosphinyl ligands, cyclopenta[b]phosphinyl ligands, cyclopenta[g]quinolyl, cyclopenta[g]isoquinolyl, indeno[1,2-c]pyridyl, and the like, including hydrogenated versions thereof, for example tetrahydroindenyl ligands.

Non-limiting examples of L^{B} include those listed for L^{A} above. Additionally L^{B} is defined as J, wherein J is represented by the formula J′—R″ₖ₋ₗ₋ⱼ and J′ is bonded to M. J′ is a heteroatom with a coordination number of three from group 15 or with a coordination number of two from group 16 of the Periodic Table of Elements, and is preferably nitrogen; R″ is selected from C₁-C₁₀₀ substituted or unsubstituted hydrocarbyl radical; k is the coordination number of the heteroatom J′ where “k-l-j” indicates the number of R″ substituents bonded to J′. Non-limiting examples of J include all isomers (including cyclics) of propylamido, butylamido, pentylamido, hexylamido, heptylamido, octylamido, nonylamido, decylamido, undecylamido, docecylamido, phenylamido, tolylamido, xylylamido, benzylamido, biphenylamido, oxo, sulfandiyl, hexylphosphido and the like.

When present, T is a bridging group containing boron or a group 14, 15 or 16 element. Examples of suitable bridging groups include R′₂C, R′₂Si, R′₂Ge, R′₂CCR′₂, R′₂CCR′₂CR′₂, R′₂CCR′₂CR′₂CR′₂, R′C═CR′, R′₂CSiR′₂, R′₂SiSiR′₂, R′₂CSiR′₂CR′₂, R′₂SiCR′₂SiR′₂, R′₂CGeR′₂, R′₂GeGeR′₂, R′₂CGeR′₂CR′₂, R′₂GeCR′₂GeR′₂, R′₂SiGeR′₂, R′B, R′₂C—BR′, R′₂C—BR′—CR′₂, R′₂C—O—CR′₂, R′₂C—S—CR′₂, R′₂C—Se—CR′₂, R′₂C—NR′—CR′₂, and R′₂C—PR′—CR′₂ where R′ is hydrogen or a C₁-C₂₀ containing hydrocarbyl or substituted hydrocarbyl and optionally two or more adjacent R′ may join to form a substituted or unsubstituted, saturated, partially unsaturated or aromatic, cyclic or polycyclic substituent.

Non-limiting examples of the bridging group T include CH₂, CH₂CH₂, CMe₂, SiMe₂, SiEt₂, SiPh₂, SiMePh, Si(CH₂)₃, Si(CH₂)₄, Si(CH₂)₅, Si(Ph-p-SiEt₃)₂, and the like.

Non-limiting examples of D and E are independently, fluoro, chloro, bromo, iodo, methyl, ethyl, benzyl, dimethylamido, methoxy, and the like.

Suitable catalysts and catalyst systems that can be used herein include but are not limited to those described in: U.S. Pat. No. 10,829,569; WO2020/167819; WO2020/167824; WO2020/167838; US2020/0255553; WO 00/24793; and WO 2021/162745 A1, each of which is incorporated by reference herein.

Preferred metallocene catalysts or metallocene catalyst precursors are cyclopentadienyl complexes which have two Cp ring systems as ligands. The Cp ligands preferably form a bent sandwich complex with the metal, and are preferably locked into a rigid configuration through a bridging group. These cyclopentadienyl complexes have the general formula:

(Cp¹Rₘ¹)Rₙ³(Cₚ²Rₚ²)MX_{q}

where Cp¹ and Cp² are preferably the same; R¹ and R² are each, independently, a halogen or a hydrocarbyl, halocarbyl, hydrocarbyl-substituted organometalloid or halocarbyl-substituted organometalloid group containing up to 20 carbon atoms; m is preferably 1 to 5; p is preferably 1 to 5; preferably two R¹ and/or R² substituents on adjacent carbon atoms of the cyclopentadienyl ring associated therewith can be joined together to form a ring containing from 4 to 20 carbon atoms; R³ is a bridging group; n is the number of atoms in the direct chain between the two ligands and is preferably 1 to 8, most preferably 1 to 3; M is a transition metal having a valence of from 3 to 6, preferably from group 4, 5, or 6 of the periodic table of the elements, and is preferably in its highest oxidation state; each X is a non-cyclopentadienyl ligand and is, independently, a hydrocarbyl, oxyhydrocarbyl, halocarbyl, hydrocarbyl-substituted organometalloid, oxyhydrocarbyl-substituted organometalloid or halocarbyl-substituted organometalloid group containing up to 20 carbon atoms; and q is equal to the valence of M minus 2. In a preferred embodiment, M is a group 4 metal, preferably Hf or Zr. In another preferred embodiment, (Cp¹Rₘ¹) and (Cp²R²p) are each, independently, a substituted or unsubstituted indenyl group.

As already mentioned, the metallocene catalyst or metallocene catalyst precursor can be activated with a non-coordinating anion. The term “non-coordinating anion” refers to an anion which either does not coordinate to the transition metal cation or which is only weakly coordinated to the cation, thereby remaining sufficiently labile to be displaced by a neutral Lewis base. “Compatible” non-coordinating anions are those which are not degraded to neutrality when the initially formed complex decomposes. Further, the anion typically will not transfer an anionic substituent or fragment to the cation so as to cause it to form a neutral four coordinate metallocene compound and a neutral by-product from the anion. Suitable non-coordinating anions are those which are compatible, stabilize the metallocene cation in the sense of balancing its ionic charge, yet retain sufficient lability to permit displacement by an ethylenically or acetylenically unsaturated monomer during polymerization. Additionally, suitable anions can be large or bulky in the sense of sufficient molecular size to largely inhibit or prevent neutralization of the metallocene cation by Lewis bases other than the polymerizable monomers that may be present in the polymerization process. Typically, the anion will have a molecular size of greater than or equal to 4 angstroms.

See also U.S. Pat. No. 8,263,707, incorporated herein by reference, for a detailed description of suitable metallocene catalyst systems.

### Tubular Reactor System

The tubular reactor system can include a form of heat removal. This heat removal can be achieved by chilling feed prior to entering the reactor. Heat removal can also be achieved by including a heat exchanger in the tubular reactor. In a preferred embodiment, the heat exchanger can be or can include a spiral heat exchanger.

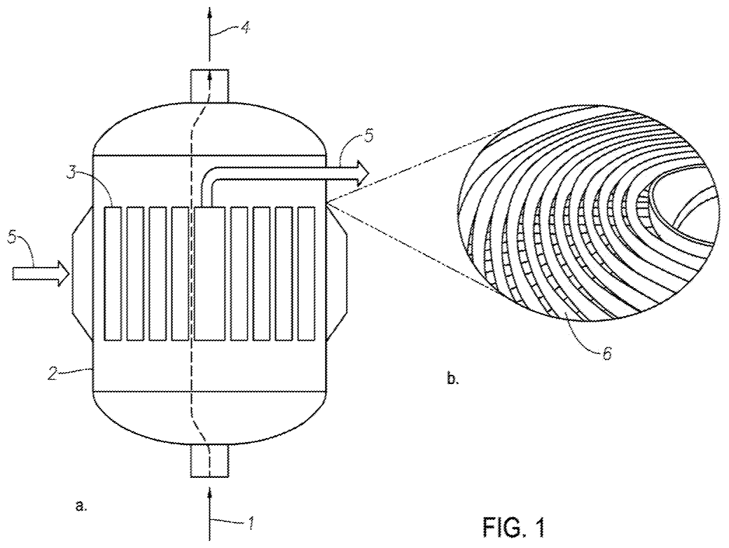

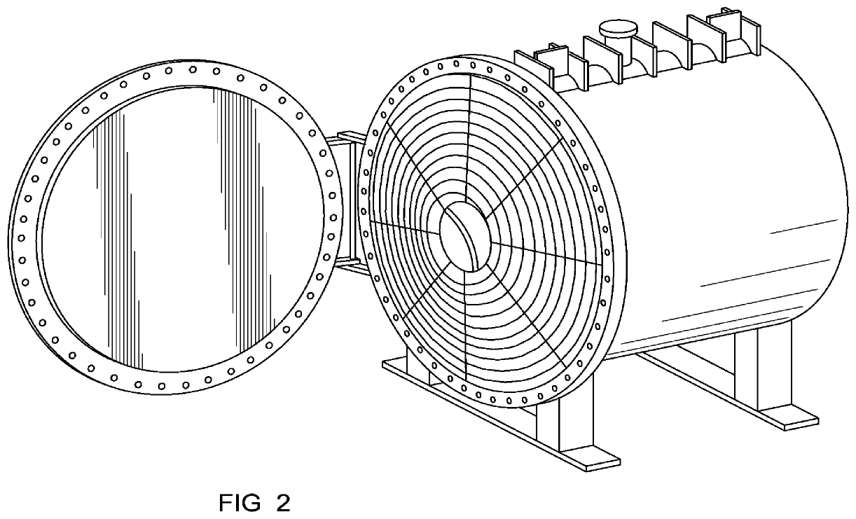

Turning to the drawings, FIG. 1a depicts a suitable tubular reactor having a spiral heat exchanger. As shown, a stream 1 comprising monomer, comonomer, and catalyst system, can enter a tubular reactor 2 and travel through a spiral heat exchanger 3. A stream 4 comprising copolymer product, unreacted monomer and/or comonomer, and quenched or unquenched catalyst system can exit the reactor 2. A stream 5 comprising heat exchange medium can flow through the spiral heat exchanger 3. The at least one spiral heat exchanger can include a body formed by at least one spiral sheet wound to form spirals which are arranged radially around an axis of the spiral heat exchanger. The spirals can form at least one flow channel for flow of a heat exchange medium, and the spirals can be enclosed by a substantially cylindrical shell, as shown in FIG. 2. Also, the cylindrical shell can include at least one inlet and at least one outlet in fluid communication with the at least one flow channel for providing and removing the heat exchange medium.

The at least one spiral heat exchanger can be oriented in a direction, for example, as shown in FIG. 1b, such that the monomer, comonomer, catalyst system, and copolymer product flow in an axial direction through channels formed in between the spirals 6 of the at least one spiral heat exchanger, thereby the feed and the polymer product as it travels through the at least one spiral heat exchanger. In other words, the monomer, comonomer, catalyst system, and copolymer product can flow through the at least one spiral heat exchanger in a cross-flow direction relative to the spirals of the at least one spiral heat exchanger. As used herein, “cross-flow” direction refers to a flow substantially orthogonal in direction to the spirals of the at least one spiral heat exchanger. Substantially orthogonal can include flow of the monomer, comonomer, catalyst system, and copolymer product at an angle of 70° to 110°, preferably 80° to 100°, more preferably 85° to 95°, even more preferably 88° to 92°, or most preferably 90°, with respect to the spirals of the at least one spiral heat exchanger.

As shown in FIG. 1a, the at least one spiral exchanger can be oriented in a substantially vertical direction such that the monomer, comonomer, catalyst system, and copolymer product flow in a substantially vertical direction through the at least one spiral heat exchanger. The orientation of the at least one spiral heat exchanger is not limited to such a vertical orientation but rather can be oriented in any direction so long as the feed and product flow through the at least one spiral heat exchanger in a cross-flow direction relative to the spirals of the at least one spiral heat exchanger. For example, the at least one spiral heat exchanger can be oriented in a substantially horizontal direction, as shown in FIG. 2, such that the monomer, comonomer, catalyst system, and copolymer product flow through the at least one spiral heat exchanger in a substantially horizontal direction.

Alternatively, the at least one spiral heat exchanger can include multiple spiral heat exchangers, e.g., at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, etc.

The at least one spiral heat exchanger used in the processes described herein can be any suitable spiral heat exchanger known in the art. Non-limiting examples of suitable spiral heat exchangers include those described in U.S. Pat. Nos. 8,622,030; 8,075,845; 8,573,290; 7,640,972; 6,874,571; 6,644,391; 6,585,034; and 4,679,621; US Publication Nos. 2010/0170665; 2010/0008833; 2002/0092646; and 2004/0244968, and International Publication No. WO/2017/058385, each of which are incorporated herein by reference. Additionally or alternatively, the at least one spiral heat exchanger can have a surface area to volume ratio of about 20-30 ft2/ft3. Advantageously, the spiral heat exchanger can have an open channel height of 0.5 to 30 feet, preferably 1 to 25 feet, 3 to 20 feet, 5 to 15 feet, or 5 to 10 feet.

The heat exchange medium that flows through the spirals of the at least one spiral heat exchanger can be any suitable heat exchange medium known in the art. Particularly useful heat exchange media are those stable at the reaction temperatures and typically include those stable at 200° C. or more. Examples of heat transfer media include water and other aqueous solutions, oil (e.g., hydrocarbons, such as mineral oil, kerosene, hexane, pentane, and the like), and synthetic media, such as those commercially available from The Dow Chemical Company (Midland, Michigan) under the trade name DOWTHERM™, such as grades A, G, J, MX, Q, RP, and T. If water is used, then the water is preferably under a suitable amount of pressure to prevent boiling. Preferably, the heat exchange medium flows through the spirals at a temperature lower than a temperature of the feed stream. Additionally, or alternatively, the heat exchange medium can flow through the spirals at a temperature above a precipitation point of the polymer. For example, the heat exchange medium can flow through the spirals at a temperature of 100° C. to 150° C., preferably 120° C. to 140° C., or more preferably 130° C.

In various aspects, the at least one spiral heat exchanger can remove heat (e.g., produced during the polymerization reaction) at a rate of > about 100 Btu/hour-cubic foot-° F. (about 1,860 W/cubic meters-° C.), > about 150 Btu/hour-cubic foot-° F. (about 2,795 W/cubic meters-° C.), >about 200 Btu/hour-cubic foot-° F. (about 3,725 W/cubic meters-° C.), > about 250 Btu/hour-cubic foot-° F. (about 4,660 W/cubic meters-° C.), > about 300 Btu/hour-cubic foot-° F. (about 5,590 W/cubic meters-° C.), > about 350 Btu/hour-cubic foot-° F. (about 6,520 W/cubic meters-° C.), >about 400 Btu/hour-cubic foot-° F. (about 7,450 W/cubic meters-° C.), > about 450 Btu/hour-cubic foot-° F. (about 8,385 W/cubic meters-° C.), > about 500 Btu/hour-cubic foot-° F. (about 9,315 W/cubic meters-° C.), > about 550 Btu/hour-cubic foot-° F. (about 10,245 W/cubic meters-° C.), >about 600 Btu/hour-cubic foot-° F. (about 11,180 W/cubic meters-° C.), > about 650 Btu/hour-cubic foot-° F. (about 12,110 W/cubic meters-° C.), > about 700 Btu/hour-cubic foot-° F. (about 13,040 W/cubic meters-° C.), > about 750 Btu/hour-cubic foot-° F. (about 13,970 W/cubic meters-° C.), or > about 800 Btu/hour-cubic foot-° F. (about 14,905 W/cubic meters-° C.). Preferably, the at least one spiral heat exchanger removes heat at a rate of about >400 Btu/hour-cubic foot-° F. (about 7,450 W/cubic meters-° C.). Ranges expressly disclosed include combinations of any of the above-enumerated values, e.g., about 100 to about 800 Btu/hour-cubic foot-° F. (about 1,860 to about 14,905 W/cubic meters-° C.), about 200 to about 650 Btu/hour-cubic foot-° F. (about 3,725 to about 12, 110 W/cubic meters-° C.), about 350 to about 550 Btu/hour-cubic foot-° F. (about 6,520 to about 10,245 W/cubic meters-° C.). Preferably, the at least one spiral heat exchanger removes heat at a rate of about 100 to about 800 Btu/hour-cubic foot-° F. (about 1,860 to about 14,905 W/cubic meters-° C.), preferably about 200 to about 700 Btu/hour-cubic foot-° F. (about 3,725 to about 13,040 W/cubic meters-° C.), or more preferably about 300 to about 500 Btu/hour-cubic foot-° F. (about 5,590 to about 9,315 W/cubic meters-° C.).

Additionally, use of the at least one spiral heat exchanger in the polymerization process described herein advantageously results in a low pressure drop, which results in higher recirculation and production rates. For example, the pressure drop across the at least one spiral heat exchanger can be < about 0.1 psi, < about 0.2 psi, < about 0.3 psi, < about 0.4 psi, < about 0.5 psi, < about 0.6 psi, < about 0.7 psi, < about 0.8 psi, < about 0.9 psi, < about 1.0 psi, < about 2.0 psi, < about 3.0 psi, < about 4.0 psi, < about 5.0 psi, < about 6.0 psi, < about 7.0 psi, < about 8.0 psi, < about 9.0 psi, < about 10.0 psi, < about 12.0 psi, < about 14.0 psi, < about 16.0 psi, < about 18.0 psi, or < about 20.0 psi. The pressure drop across the at least one spiral heat exchanger can be < about 10.0 psi, preferably < about 5.0 psi, or more preferably < about 1.0 psi. Ranges expressly disclosed include combinations of any of the above-enumerated values, e.g., about 0.1 psi to about 20.0 psi, about 0.5 psi to about 16.0 psi, about 1.0 psi to about 12 psi, about 3.0 psi to about 8.0 psi, etc. Preferably, pressure drop across the at least one spiral heat exchanger is about 0.1 psi to about 14.0 psi, more preferably about 0.5 psi to about 10.0 psi, or even more preferably about 0.8 psi to about 2.0 psi, or alternately from 0.2 to 0.8 psi per stage.

In various aspects, the monomer, the comonomer, the catalyst system, and the polymer can be maintained substantially as a single liquid phase under polymerization conditions. While he flow of the liquid through the at least one spiral heat exchanger can be plug flow in form, the flow is preferably laminar or near-laminar. Preferably, the Reynolds number of the flow of the liquid can be > about 0.1, > about 1.0, > about 10.0, > about 20.0, > about 30.0, > about 40.0, >about 50.0, > about 60.0, > about 70.0, > about 80.0, > about 90.0, > about 100, > about 200, >about 300, > about 400, > about 500, > about 600, > about 700, > about 800, > about 900, > about 1,000, > about 1,100, > about 1,200, > about 1,300, > about 1,400, > about 1,500, > about 1,600, > about 1,700, > about 1,800, > about 1,900, > about 2,000, > about 2,100, or about 2,200. Additionally or alternatively, the Reynolds number of the flow of the liquid can be < about 40.0, < about 50.0, ≤ about 60.0, ≤ about 70.0, ≤ about 80.0, ≤ about 90.0, ≤ about 100, ≤ about 200, < about 300, ≤ about 400, ≤ about 500, ≤ about 600, ≤ about 700, ≤ about 800, ≤ about 900, ≤ about 1,000, ≤ about 1,100, ≤ about 1,200, ≤ about 1,300, ≤ about 1,400, ≤ about 1,500, ≤ about 1,600, ≤ about 1,700, ≤ about 1,800, ≤ about 1,900, ≤ about 2,000, ≤ about 2,100 or < about 2,200. Ranges expressly disclosed include combinations of any of the above-enumerated values, e.g., about 0.1 to about 2,200, about 1.0 to about 1,400, about 1.0 to about 100, about 50.0 to about 900, etc. Preferably, the Reynolds number of the liquid is about 0.1 to about 2,200, preferably about 1.0 to about 1,000, preferably about 1.0 to about 100, more preferably about 1.0 to about 50. Reynolds number is calculated using the hydraulic diameter (Dh) and the hydraulic diameter (Dh) and is defined as Dh=4A/P, where A is the cross-sectional area and P is the wetted perimeter of the cross-section of a channel in the spiral heat exchanger. Zero shear viscosity is used for Reynolds number calculation when a non-Newtonian fluid is used.

In various aspects, the polymerization process can be conducted at a temperature of from about 50° C. to about 220° C., preferably from about 70° C. to about 210° C., preferably from about 90° C. to about 200° C., preferably from about 100° C. to about 190° C., or preferably from about 130° C. to about 160° C. The polymerization process can be conducted at a pressure of from about 120 to about 1,800 psi (827.371 to 12,410.560 kPa), preferably from about 200 to about 1,000 psi (1,378.950 to 6,894.760 kPa), preferably from about 300 to about 800 psi (2,068.430 to 5,515.810 kPa).

In various aspects, residence time in the at least one spiral heat exchanger can be up to 24 hours or longer, typically from about 1 minute to about 15 hours. The residence time is preferably from about 2 minutes to about 1 hour, from about 3 to about 30 minutes, from about 5 to about 25 minutes, or from about 5 to about 20 minutes.

In various aspects, hydrogen can be present during the polymerization process at a partial pressure of from about 0.001 to about 50.000 psig (0.007 to 344.738 kPa), preferably from about 0.010 to about 25.000 psig (0.069 to 172.369 kPa), more preferably from about 0.100 to about 10.000 psig (0.689 to 482.633 kPa). Alternatively, the hydrogen concentration in the feed can be 500 wppm or less, preferably 200 wppm or less.

In various aspects, the cement concentration of the polymer produced can range from about 2 wt % to about 40 wt %, preferably from about 5 wt % to about 30 wt %, or more preferably from about 6 wt % to about 25 wt %. “Cement concentration” is herein defined to be the weight of the polymer produced based on the weight of the total solvent (e.g., monomer, comonomer, and/or solvent).

The polymerization process can further include recycling at least a portion of the solvent, the monomer/comonomer, the catalyst system, and the polymer exiting the at least one reactor back through the reactor. In various aspects, the propylene-based copolymer can be produced with a recycle ratio ranging from about 0.1 to about 50.0, preferably from about 3.0 to about 30.0, and even more preferably from about 3.0 to about 15.0. The “recycle ratio” is herein defined to be the ratio between the flow rate of the recycle loop just prior to entry into the spiral heat exchanger (alone or in series) divided by the flow rate of fresh feed to the spiral heat exchanger (alone or in series).

The recycle ratio may be used to achieve a broad composition distribution. In an embodiment, the recycle ratio remains constant during the reaction while the monomer conversion varies across different zones along the axial length of each tubular reactor as the propylene-based copolymer is produced. A lower recycle ratio creates greater variation in the monomer conversion due to less mixing, flow, and solution uniformity, while a higher recycle ratio generally creates more uniform conversion due to higher mixing and more solution uniformity, all other factors being equal. While a conventional CSTR process is limited to certain variables, such as temperature or pressure, in order to control the conversion, the tubular reactor offers an additional method to control conversion via recycle ratio. That is, the recycle ratio may be varied from one polymerization reaction to the next in a tubular reactor, while it may not be varied in a CSTR. The conversion for the tubular reactor can range from about 30% to about 90%, preferably from about 30% to about 60%, and even more preferably from about 45% to about 55%. Greater variation in conversion results in polymer product having a broader composition distribution, while lower variation in conversion results in a polymer product having a narrower composition distribution.

In various aspects, different zones can be disposed along the tubular reactor which may be isothermal or adiabatic. Preferably, about 60% of the copolymer is produced isothermally, and about 40% of the copolymer is produced adiabatically.

### EXAMPLES

The foregoing discussion can be further described with reference to the following non-limiting examples.

### Example 1

Four samples of high-viscosity copolymers of C3 and C2 (C3/C2 copolymers) were made as follows using a SHE reactor commercially available from Tranter® (hereinafter “Tranter SHE reactor”) at different recycle ratios and a single metallocene-based catalyst system. The C3 monomer, the C2 comonomer, the metallocene (MCN) catalyst, i.e., dimethyl silyl bis(indenyl) hafnium dimethyl, and the catalyst activator, i.e., dimethyl anilinium tetrakis (heptafluoronaphthyl) borate, were added to the reactor to start the solution phase polymerization. The first, second, and third C3/C2 copolymer samples were produced at recycle ratios (RRs) of 24, 9, and 7, respectively (Comparative Example 2, Example 1a, and 1b). The fourth C3/C2 copolymer sample was produced under conditions where in-reactor heat removal (QR) was greater than the heat removed by chilling the feeds (QF) (represented as QF<QR). This sample was also made using a RR of 7 (Example 1c). The process conditions employed for Ex. 1a-1c are shown in Table 1 below.

A sample of Vistamaxx™ 6200 (Comparative Example 1), which is a high-viscosity C3/C2 copolymer made by ExxonMobil using a MCN catalyst and a CSTR reactor, was obtained for comparison purposes.

TABLE 1
Process Conditions for Ex. 1a-1c

| Example | Ex. 1a | Ex. 1b | Ex. 1c |
|---|---|---|---|
| Catalyst Flow (cc/min) | 0.90 | 0.15 | 0.18 |
| Activator Flow (cc/min) | 0.90 | 0.15 | 0.18 |
| Reactor Inlet Temperature (° C.) | 65.28 | 97.03 | 93.03 |
| Reactor Outlet Temperature (° C.) | 61.95 | 97.99 | 88.98 |
| Reactor Pressure (psig) | 501.46 | 505.08 | 505.55 |
| C6 Feed (kg/hr) | 27.81 | 26.80 | 27.00 |
| C3 Feed (kg/hr) | 5.20 | 6.21 | 6.02 |
| C2 Feed (kg/hr) | 1.50 | 1.56 | 1.48 |
| Hydrogen Feed (sccm) | 0 | 0 | 0 |
| Cement Conc. (wt %) | 16.72 | 19.21 | 17.19 |
| H₂/C3 Feed (wppm) | 0 | 0 | 0 |
| C2 Conversion (%) | 66.90 | 72.31 | 64.16 |
| C3 Conversion (%) | 91.67 | 88.77 | 82.77 |
| C2 In-reactor Concentration (wt %) | 1.44 | 1.25 | 1.54 |
| C3 In-reactor Concentration (wt %) | 1.26 | 2.02 | 3.01 |

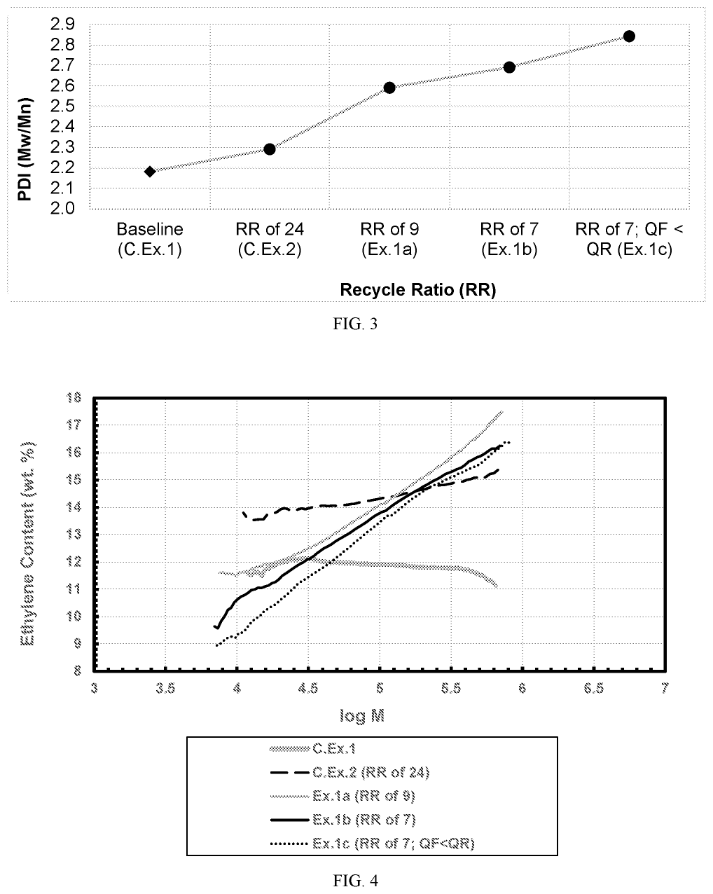

As shown in FIG. 3, the MWDs or PDIs (Mw/Mn) of all C3/C2 copolymer samples (Ex.1a-1c and C.Ex.1-2) were determined and plotted as a function of recycle ratio. Ideally, a CSTR represents a well-mixed reactor fluid, whereas a SHE reactor allows for different degrees of mixing. A RR of about 30 approaches the well-mixed state typical of a CSTR for these types of materials. Decreasing the RR surprisingly resulted in an increase in the PDI and a broadening of the MWD of the inventive copolymer samples of Ex. 1a-1c. It is believed that this broadening of the MWD occurred because reducing the RR reduced the amount of material flowing back into the SHE reactor and thus reduced the degree of in-reactor mixing. As demonstrated in FIG. 3, at a RR of 24 the PDI of C.Ex.2 is much closer to that of C.Ex.1 indicating the SHE reactor includes and expands upon the capability of the CSTR.

As depicted in FIG. 4, the C2 comonomer content was plotted as a function of log scale molecular weight (M) for each sample to illustrate the CD of each sample. As shown, decreasing the RR caused the slope of the CD to increase, which indicates a wider variety of polymer chains produced in the same reaction having different amounts of C2 incorporated. The sample of C.Ex.1, which was made using a CSTR reactor, had the lowest PDI at 2.2 or the narrowest MWD and the most uniform CD with almost no slope compared to all other samples made on the SHE reactor (Ex. 1a-1c). Therefore, the RR on the SHE reactor serves as a parameter by which in-reactor mixing can be tuned, despite using the same catalyst and reaction scheme. In this way, it was found that process control with the simplicity of single reactor operation, rather than change in catalyst or use of two reactors, surprisingly affords tunable degrees of breadth in molecular weight and composition distributions. Such tunability also includes polymer structure similar to that which is made on a CSTR, as exhibited by C.Ex.2 at a RR of 24.

The samples of Ex.1a-1c, which were produced at various RR on the SHE loop reactor, not only demonstrated broader CDs compared to the sample of C.Ex.1 and C.Ex.2, but they also exhibited broad orthogonal composition distributions (BOCDs), as indicated by the positive slopes of the CD profiles of Ex. 1a-1c. BOCD is used to describe the instance where lower molecular weight species have a lower comonomer content and higher molecular weight species have higher comonomer content within a given distribution. Having a BOCD offers advantages in polymer performance, processing, and pellet stability but has never been achieved through a single-reactor CSTR process. The ability to achieve a BOCD structure is yet another unexpected benefit of the SHE loop reactor.

As a final comparison, the CD profiles of several of ExxonMobil's High Viscosity Vistamaxx™ (HVV) grades (Comparative Example 3-6) are shown in FIG. 5, all of which are made using dual CSTR reactors except for C.Ex.6, a sample of Vistamaxx™ 3980 made using a single CSTR reactor. Regardless of dual-reactor operation, these grades all exhibited a relatively uniform CD in stark contrast to the single-reactor SHE samples of Ex. 1a-1c.

The copolymer samples of Ex.1a (RR of 9), C.Ex.2 (RR of 24), and C.Ex.1 were separately blended with pp 3155 homopolymer, which is commercially available from ExxonMobil, at a weight ratio of 80:20 (PP to C3/C2 copolymer), to form blend compositions suitable for soft non-woven fabric applications. Atomic force microscopy (AFM) images were taken of the blend compositions. Surprisingly, the blend composition containing the copolymer sample made at a RR of 9 (Ex.1a) exhibited smaller particle sizes within the continuous PP phase than did the copolymer sample made at a RR of 24 (C.Ex.2) and the CSTR-made sample of C.Ex.1, which both exhibited larger particle sizes. A smaller particle size indicates a higher area of interface between the C3/C2 copolymer and the PP homopolymer and thus a more favorable interaction attributed to broad MWDs and CDs. In contrast, a larger particle size correlates to a more uniform distribution of molecules.

### Example 2

In a similar manner to the samples of Example 1, two samples of low-viscosity C3/C2 copolymers (Example 2a and Example 2b) as opposed to high-viscosity C3/C2 copolymers were made using a RR of 16 and 10, respectively. The process conditions, which were varied to produce these lower molecular weight, lower viscosity samples, are provided in Table 2 below.

TABLE 2
Process Conditions for Ex. 2a-2b

| Example | Ex. 2a | Ex. 2b |
|---|---|---|
| Catalyst Flow (cc/min) | 1.60 | 2.03 |
| Activator Flow (cc/min) | 1.60 | 2.03 |
| Reactor Inlet Temperature (° C.) | 111.37 | 97.65 |
| Reactor Outlet Temperature (° C.) | 113.31 | 99.52 |
| Reactor Pressure (psig) | 499.26 | 498.54 |
| C6 Feed (kg/hr) | 21.83 | 23.76 |
| C3 Feed (kg/hr) | 6.17 | 4.24 |
| C2 Feed (kg/hr) | 0.80 | 0.65 |
| Hydrogen Feed (sccm) | 222.05 | 199.94 |
| Cement Conc. (wt %) | 9.65 | 6.88 |
| H₂/C3 Feed (wppm) | 180.03 | 235.84 |
| C2 Conversion (%) | 48.62 | 51.68 |
| C3 Conversion (%) | 38.74 | 38.59 |
| C2 In-reactor Concentration (wt %) | 1.43 | 1.09 |
| C3 In-reactor Concentration (wt %) | 13.12 | 9.09 |

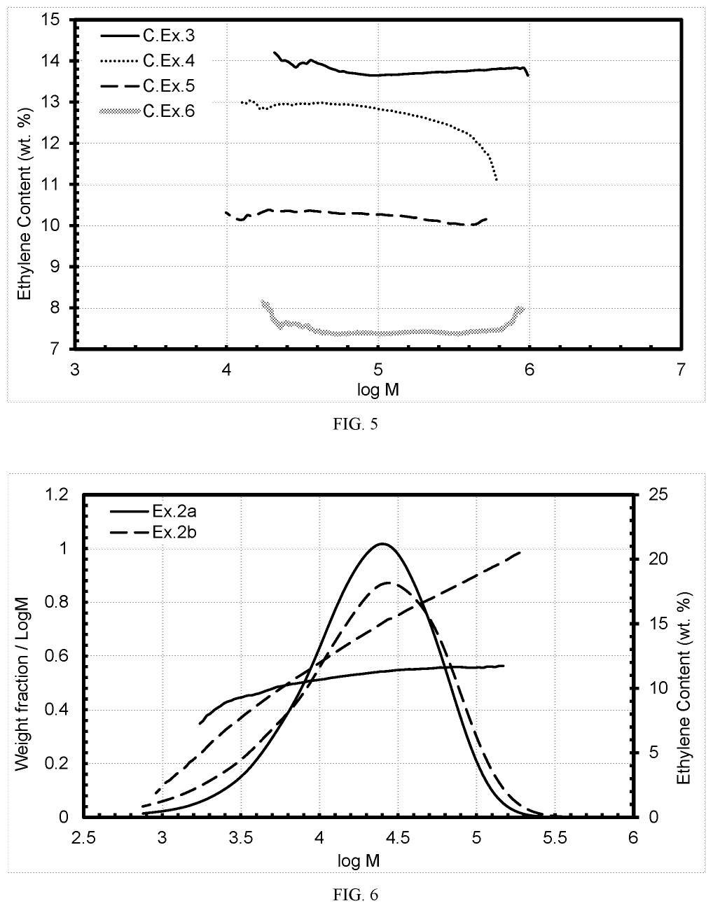

FIG. 6 depicts graphs of the MWDs and CDs of the samples of Ex.2a-2b. As shown, the copolymer sample formed using a RR of 10 (Ex.2b) exhibited a broader MWD and a broader, more positively sloped CD (an indicator of BOCD) than the copolymer sample formed using a RR of 16 (Ex.2a). Therefore, low-viscosity C3/C2 copolymers made using a SHE loop reactor behave similarly to high-viscosity C3/C2 copolymers made using a SHE loop reactor in that they demonstrate broadening of MWD and CD with a decrease in RR.

### Example 3

A C3/C2 copolymer sample (Example 3) was made in a similar manner as the samples of Example 1 with the exception that the process conditions were different and two SHE reactors in parallel, which are commercially available from Alfa Laval Inc. (hereinafter “Alfa Laval SHE reactor”), were employed instead of the single Tranter SHE reactor. The Alfa Laval SHE reactor loop has a different ratio of isothermal to adiabatic regions than the Tranter SHE reactor loop. The process conditions used to produce the sample of Ex. 3 are presented in Table 3 below.

TABLE 3
Process Conditions of Ex. 3

Ex. 3

| | Reactor 1 | Reactor 2 |
|---|---|---|
| | (90% | (10% |
| Example | component) | component) |
| Catalyst Flow (cc/min) | 0.34 | 0.54 |
| Activator Flow (cc/min) | 0.34 | 0.54 |
| Reactor Inlet Temperature (° C.) | 65.46 | 87.72 |
| Reactor Outlet Temperature (° C.) | 67.03 | 89.79 |
| Reactor Pressure (psig) | 528.22 | 495.92 |
| C6 Feed (kg/hr) | 26.66 | 6.89 |
| C3 Feed (kg/hr) | 8.33 | 3.41 |
| C2 Feed (kg/hr) | 1.55 | 0.06 |
| Hydrogen Feed (sccm) | 0.00 | 0.00 |
| Cement Conc. (wt %) | 20.55 | 5.41 |
| H₂/C3 Feed (wppm) | 0.00 | 0.00 |
| C2 Conversion (%) | 77.68 | 50.00 |
| C3 Conversion (%) | 75.72 | 13.59 |
| C2 In-reactor Concentration (wt %) | 0.94 | 0.29 |
| C3 In-reactor Concentration (wt %) | 5.53 | 28.42 |

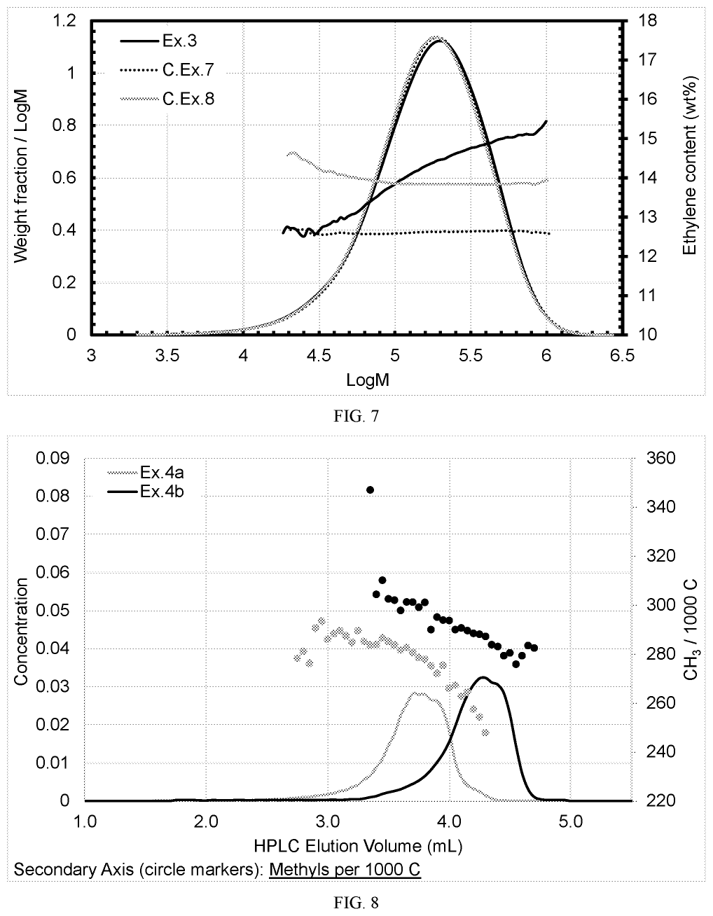

FIG. 7 depicts graphs of the MWDs and CDs of the C3/C2 copolymer sample of Ex.3. For comparison purposes, FIG. 7 also depicts graphs of the MWDs and CDs of C3/C2 copolymer samples of Vistamaxx™ 6102 made under similar process conditions but at different plants using dual CSTR reactors (Comparative Examples 7 and 8). Despite the change in heat transfer profile and manufacturer of the SHE reactor relative to Ex.1-2, the SHE reactor design continued to demonstrate the capability to produce a C3/C2 polymer sample (Ex.3) with a BOCD. In contrast, the samples of C.Ex.7-8 exhibited a uniform CD, as indicated by the almost zero slopes of the CD profiles of these samples.

### Example 4

Two C3/C2 copolymer samples (Examples 4a and 4b) were made in a similar manner to the sample of C.Ex.2 (RR of 24) except that the sample of Ex.4b was made in an Alfa Laval SHE reactor having different amounts of isothermal and adiabatic reaction volume. The process conditions used to make the samples of Ex.4a-4b are shown in Table 4 below.

TABLE 4
Process Conditions of Ex. 4a-4b

| Example | Ex. 4a | Ex. 4b |
|---|---|---|
| Catalyst Flow (cc/min) | 1.11 | 0.56 |
| Activator Flow (cc/min) | 1.11 | 0.56 |
| Reactor Inlet Temperature (° C.) | 70.23 | 90.22 |
| Reactor Outlet Temperature (° C.) | 68.54 | 92.99 |
| Reactor Pressure (psig) | 500.36 | 512.15 |
| C6 Feed (kg/hr) | 29.01 | 25.77 |
| C3 Feed (kg/hr) | 10.99 | 11.72 |
| C2 Feed (kg/hr) | 1.50 | 1.50 |
| Hydrogen Feed (sccm) | 0.00 | 0.00 |
| Cement Conc. (wt %) | 19.75 | 18.66 |
| H₂/C3 Feed (wppm) | 0.00 | 0.00 |
| C2 Conversion (%) | 95.62 | 78.63 |
| C3 Conversion (%) | 61.55 | 52.04 |
| C2 In-reactor Concentration (wt %) | 0.16 | 0.82 |
| C3 In-reactor Concentration (wt %) | 10.18 | 14.41 |

The samples of Ex.4a-4b were subjected to fractionation through high performance liquid chromatography-size exclusion chromatography (HPLC-SEC). FIG. 8 depicts the chromatograms of the samples of Ex.4a-4b and illustrates that these samples have a similar breadth as far as comonomer incorporation and/or sequence length distribution. This provides further evidence of the robustness of the technique where despite a change in the reactor manufacturer or the ratio of isothermal to adiabatic reaction volumes, products of a similar distribution can be produced.

### Example 5

Three C3/C2 copolymer samples (Comparative Example 9-10 and Example 5) were made in a similar manner to the samples of Example 1 but at RRs of 12, 6, and 3, respectively, and using an Alfa Laval SHE reactor. The process conditions used to make the samples of Ex.5 are shown in Table 5 below.

TABLE 5
Process Conditions of Ex. 5

| Example | Ex. 5 |
|---|---|
| Catalyst Flow (cc/min) | 2.13 |
| Activator Flow (cc/min) | 2.12 |
| Reactor Inlet Temperature (° C.) | 57.54 |
| Reactor Outlet Temperature (° C.) | 62.99 |
| Reactor Pressure (psig) | 595.25 |
| C6 Feed (kg/hr) | 38.92 |
| C3 Feed (kg/hr) | 9.10 |
| C2 Feed (kg/hr) | 1.40 |
| Hydrogen Feed (sccm) | 0 |
| Cement Conc. (wt %) | 13.14 |
| H₂/C3 Feed (wppm) | 0 |
| C2 Conversion (%) | 82.56 |
| C3 Conversion (%) | 58.62 |
| C2 In-reactor Concentration (wt %) | 0.49 |
| C3 In-reactor Concentration (wt %) | 7.62 |

The MWD and CD profiles of the copolymer samples of C.Ex.9-10 and Ex.5 are shown in FIG. 9. The samples of C.Ex.9-10 and Ex.5 exhibited a similar trend to the samples of C.Ex.2 and Ex. 1a-1b in that the CD became broader (more sloped) as the RR was decreased while the MWD remained mostly unaffected. It is believed that this trend happens because the SHE reactor temperature and monomer concentrations have a larger variance along the loop at lower RR, leading to in-reactor differences in reaction kinetics and comonomer incorporation.

### Example 6

The C3/C2 copolymer sample of Ex.3 was mixed with pp 3155, which is an Exxon Mobil PP homopolymer, in a brabender at a weight ratio of 15:85 to form a blend formulation (Example 6). For comparison purposes, a blend of Vistamaxx™ 6102 made using a CSTR and pp 3155 was prepared in a similar manner (Comparative Example 11). Such blends could be applied to elastic films, e.g., for hygiene applications such as diapers. Various physical properties, including elastic properties, of the formulations of Ex.6 and C.Ex.11 were determined and tabulated in Table 6 below. While the melt flow rate (MFR), tensile properties, and flex modulus of these formulations are similar, the formulation of Ex.6 (containing C3/C2 copolymer made with a SHE loop reactor) unexpectedly demonstrated enhanced elasticity by having lower top load, lower load loss, lower permanent set, and smaller mechanical hysteresis than the formulation of C.Ex.11 (containing C3/C2 copolymer made with a CSTR).

TABLE 6
Properties of the Blend Formulations of Ex. 6 and C. Ex. 11

| Property | Units | C. Ex. 11 | Ex. 6 |
|---|---|---|---|
| MI (2.16 kg/190° C.) | g/10 min | 1.7 | 1.7 |
| MFR (2.16 kg/230° C.) | g/10 min | 4.1 | 3.9 |

Mechanical Properties

| | | | |
|---|---|---|---|
| Tensile stress at break | MPa | 7.1 | 7.1 |
| Tensile strain at break | % | 569 | 582 |
| Stress at 100% strain | MPa | 2.2 | 2.1 |
| Stress at 200% strain | MPa | 2.9 | 2.7 |
| Stress at 300% strain | MPa | 3.9 | 3.7 |
| Tensile modulus (1% secant) | MPa | 16 | 14 |
| Flexural modulus (1% secant) | MPa | 21 | 22 |

Elastic Properties
Hysteresis 100% stretch and return (2 cycles) - 50 mm width

| | | | |
|---|---|---|---|
| First Cycle | | | |
| Load at 50% strain | N | 50 | 45 |
| Top load (max load) | N | 58 | 51 |
| Retractive Force (unload @ 50% strain) | N | 12 | 14 |
| Load loss | % | 76 | 68 |
| Permanent set | % | 17 | 14 |
| Mechanical hysteresis | % | 69 | 62 |
| Second Cycle | | | |
| Load at 50% strain | N | 26 | 26 |
| Top load (max load) | N | 51 | 46 |
| Unload @ 50% strain | N | 11 | 13 |
| Load loss | % | 60 | 51 |
| Permanent set | % | 13 | 9 |
| Mechanical hysteresis | % | 50 | 43 |

Cross sections of the blend formulations of Ex.6 and C.Ex.11 were then imaged by AFM, and the images were analyzed for particle size throughout the continuous PP phase. The formulation of Ex. 6 had an average particle diameter of 39 nm, whereas the formulation of C.Ex.11 had an average particle diameter of 85 nm. The surprisingly smaller average particle diameter in the formulation of Ex.6 indicates more favorable interaction of the C3/C2 copolymer with the PP phase. It is believed that the BOCD of the formulation of Ex.6 improved the compatibility of the copolymer with the PP homopolymer, thereby amplifying the elasticity of this formulation.

### Example 7

Three C3/C2 copolymer samples (Examples 7, and Comparative Examples 12-13) were made in a similar manner to the sample of Example 3 with a dual-reactor setup using Alfa-Laval SHE reactors but with increasingly uniform CD. The process conditions used to make the samples of Ex.7 are shown in Table 7 below.

TABLE 7
Process Conditions of Ex. 7

| | Ex. 7 | |
|---|---|---|
| | Reactor 1 | Reactor 2 |
| Example | (90% component) | (10% component) |
| Catalyst Flow (cc/min) | 0.34 | 0.54 |
| Activator Flow (cc/min) | 0.34 | 0.54 |
| Reactor Inlet Temperature (° C.) | 65.46 | 87.72 |
| Reactor Outlet Temperature (° C.) | 67.03 | 89.79 |
| Reactor Pressure (psig) | 528.22 | 495.92 |
| C6 Feed (kg/hr) | 26.66 | 6.89 |
| C3 Feed (kg/hr) | 8.33 | 3.41 |
| C2 Feed (kg/hr) | 1.55 | 0.06 |
| Hydrogen Feed (sccm) | 0.00 | 0.00 |
| Cement Conc. (wt %) | 20.55 | 5.41 |
| H₂/C3 Feed (wppm) | 0.00 | 0.00 |
| C2 Conversion (%) | 77.68 | 50.00 |
| C3 Conversion (%) | 75.72 | 13.59 |
| C2 In-reactor Concentration (wt %) | 0.94 | 0.29 |
| C3 In-reactor Concentration (wt %) | 5.53 | 28.42 |

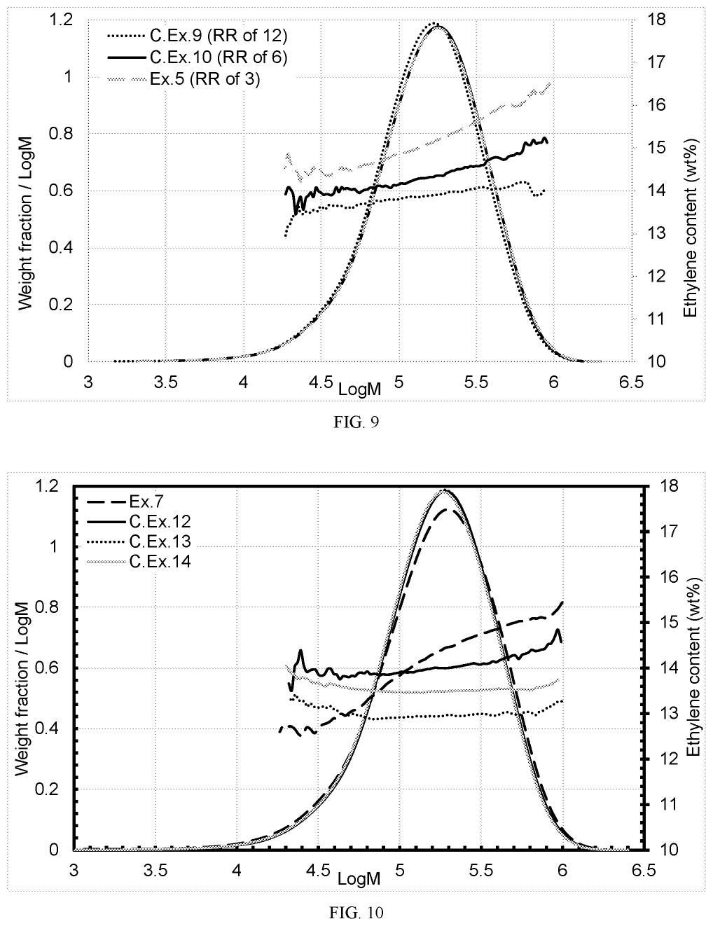

The MWD and CD profiles of the samples of Ex. 7 and C.Ex. 12-13 are illustrated in FIG. 10. For comparison purposes, the MWD and CD profile of a Vistamaxx™ 6102 sample (Comparative Example 14) made using a conventional CSTR process are also shown in FIG. 10. Comparing the CD profile of the sample having the most uniform CD (C.Ex.13) to that of the sample of C.Ex.14 reveals that a SHE loop reactor encompasses the capability of a CSTR to produce uniform CDs, if desired. Thus, the SHE loop reactor surprisingly affords tunability of both MWD and CD.

### Example 8

Three C3/C2 copolymer samples (Examples 8 and Comparative Examples 15-16) were made in a similar manner to the samples of Example 1 with the exception that the CD was controlled to have the opposite slope (a negative slope). The sample of Ex.8 was made with about a 1 wt % reduction in C2 content relative to the sample of C.Ex.15, and the sample of C.Ex.16 was made with about a 2 wt % reduction in C2 content relative to the sample of C.Ex.15. The process conditions used to make the samples of Ex.8 are shown in Table 8 below.

TABLE 8
Process Conditions of Ex. 8

| Example | Ex. 8 |
|---|---|
| Catalyst Flow (cc/min) | 0.52 |
| Activator Flow (cc/min) | 0.52 |
| Reactor Inlet Temperature (° C.) | 90.20 |
| Reactor Outlet Temperature (° C.) | 92.99 |
| Reactor Pressure (psig) | 512.48 |
| C6 Feed (kg/hr) | 24.85 |
| C3 Feed (kg/hr) | 12.66 |
| C2 Feed (kg/hr) | 1.40 |
| Hydrogen Feed (sccm) | 0.00 |
| Cement Conc. (wt %) | 18.55 |
| H₂/C3 Feed (wppm) | 0.00 |
| C2 Conversion (%) | 69.60 |
| C3 Conversion (%) | 49.33 |
| C2 In-reactor Concentration (wt %) | 1.09 |
| C3 In-reactor Concentration (wt %) | 16.49 |

FIG. 11 graphs the MWDs and CDs of the samples of Ex.8 and C.Ex.15-16. as well as the MWDs and CDs of Vistamaxx™ 6200 samples made using a CSTR process at different ExxonMobil plants (Comparative Examples 17 and 18). As shown in Table 9, the negative CD slopes of the samples of Ex.8 and C.Ex.15-16 demonstrate the versatility of the SHE reactor processes disclosed herein.

TABLE 9
Quantification of CD Slopes for the Copolymers of
Ex. 8 and C. Ex. 15-18

| Property | | Ex. 8 | C. Ex. 15 | C. Ex. 16 | C. Ex. 17 | C. Ex. 18 |
|---|---|---|---|---|---|---|
| Mw | g/mol | 146,002 | 142,768 | 144,764 | 140,130 | 138,647 |
| Mn | g/mol | 66,548 | 65,552 | 67,518 | 66,422 | 63,714 |
| Mz | g/mol | 249,189 | 242,392 | 246,277 | 230,352 | 233,523 |
| Mw/Mn | | 2.2 | 2.2 | 2.1 | 2.1 | 2.2 |
| Mz/Mw | | 1.7 | 1.7 | 1.7 | 1.6 | 1.7 |
| Slope 25 | | −3.4 | −2.1 | −0.4 | 0.1 | −0.1 |
| Slope 50 | | −1.0 | −0.5 | 0.2 | −0.3 | −0.3 |
| Slope 75 | | 0.4 | 0.5 | 0.2 | −1.0 | −0.3 |

### Example 9

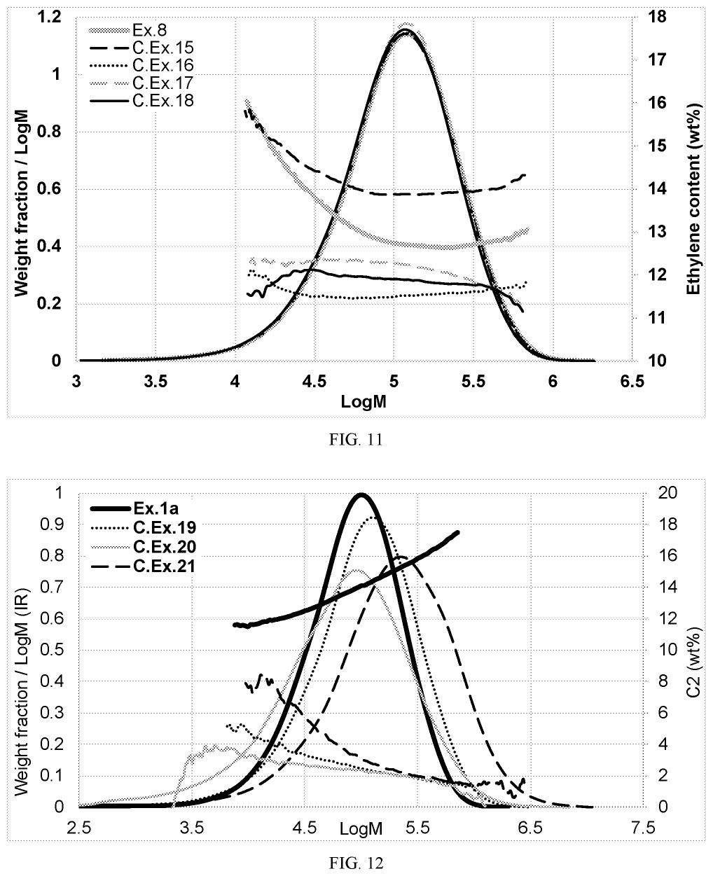

The following PP random copolymers (RCPS) made using Ziegler-Natta (Z-N) catalyst were obtained for comparison with the C3/C2 copolymer sample of Ex. 1a (RR of 9): pp 9074MED commercially available from ExxonMobil (Comparative Example 19); RJ766MO commercially available from Borealis AG (Comparative Example 20); and Pro-fax RP311H sold by LyondellBasell Industries (Comparative Example 21). FIG. 12 depicts the MWD and CD profiles of each of these samples. The RCP samples made with Z—N catalyst had a substantially different CD from that of the inventive sample of Ex.1a. The RCP samples of C.Ex. 19-21 exhibited a reduction in the comonomer content with an increase of M rather than having a BOCD like the sample of Ex.1a. The inventive sample of Ex. 1a had a PDI of 2.6 and thus a broader MWD than the MWDs of conventional metallocene products, which typically have a PDI of 2.0 to 2.2. Yet the inventive sample of Ex. 1a had a narrower MWD that that of the RCP samples of C.Ex. 19-21, which were made with Z—N catalyst. Conventional RCPS made with metallocene catalyst also typically exhibit a flat CD profile indicative of a uniform CD in contrast to the non-uniform, broad CD exhibited by the inventive propylene-based copolymers disclosed herein.

### Example 10

For each of the inventive C3-based copolymers characterized by a broad orthogonal comonomer distribution, the CD slope 25, CD slope 50, and CD slope 75 were calculated. The same calculation was done on the copolymers in the comparative examples plotted in overlay in FIGS. 4, 7, 9, and 10 and on the additional copolymers in the comparative example shown in FIG. 5. The results are shown in Table 10 below. Various properties of the copolymers of certain examples and comparative examples were also determined, as shown in Table 11 below.

TABLE 10
Quantification of CD Slopes for Copolymers of Certain Examples

| Example | Slope 25 | Slope 50 | Slope 75 |
|---|---|---|---|
| Ex. 1a | 2.2 | 3.1 | 3.9 |
| Ex. 1b | 3.4 | 3.2 | 3.0 |
| Ex. 1c | 4.1 | 3.7 | 3.3 |
| Ex. 2a | 3.0 | 1.3 | 0.8 |
| Ex. 2b | 9.5 | 7.5 | 6.4 |
| Ex. 3 | 1.9 | 2.2 | 1.4 |
| Ex. 5 | 0.6 | 1.5 | 1.8 |
| Ex. 7 | 1.9 | 2.2 | 1.4 |
| C. Ex. 1 | −0.1 | −0.3 | −0.3 |
| C. Ex. 2 | 0.7 | 0.9 | 1.1 |
| C. Ex. 3 | −0.5 | −0.1 | 0.2 |
| C. Ex. 4 | 0.1 | −0.6 | −1.4 |
| C. Ex. 5 | 0.1 | −0.1 | −0.4 |
| C. Ex. 6 | −0.6 | 0.0 | 0.5 |
| C. Ex. 7 | 0.0 | 0.0 | 0.1 |
| C. Ex. 8 | −0.9 | −0.1 | 0.1 |
| C. Ex. 9 | 0.7 | 0.4 | 0.2 |
| C. Ex. 10 | 0.5 | 0.8 | 1.1 |
| C. Ex. 12 | 0.0 | 0.4 | 0.8 |
| C. Ex. 13 | −0.3 | 0.1 | 0.2 |
| C. Ex. 14 | −0.5 | 0.0 | 0.2 |

TABLE 11
Properties of the Copolymers of Certain Examples

| | Ethylene | | | | | | | |
|---|---|---|---|---|---|---|---|---|
| Selected | content | MFR | | | | | | |
| Examples | wt % by | g/10 | BV | Mw | Mn | Mz | Mw/ | Mz/ |
| Units | IR | min | cP | g/mol | g/mol | g/mol | Mn | Mw |
| Ex. 2a | 15.4 | | 1,635 | 29,450 | 12,287 | 53,101 | 2.4 | 1.8 |
| Ex. 2b | 16.1 | | 1,903 | 32,487 | 9,956 | 66,578 | 3.3 | 2.0 |
| Ex. 5 | 17.8 | 4 | — | 210,000 | 101,700 | 342,800 | 2.1 | 1.6 |
| Ex. 7 | 7.4 | — | 1,790 | 35,979 | 14,257 | 74,962 | 2.5 | 2.1 |
| Ex. 8 | 15.6 | — | — | 146,002 | 66,548 | 249,189 | 2.2 | 1.7 |
| C. Ex. 1 | 14.5 | 19 | — | 138,647 | 63,714 | 233,523 | 2.2 | 1.7 |
| C. Ex. 4 | 15.1 | 21 | — | 133,727 | 65,182 | 218,918 | 2.1 | 1.6 |
| C. Ex. 5 | 13.0 | 46 | — | 115,208 | 53,006 | 193,093 | 2.2 | 1.7 |
| C. Ex. 6 | 8.9 | 9 | — | 200,343 | 96,808 | 328,937 | 2.1 | 1.6 |
| C. Ex. 7 | 15.9 | 3 | — | 231,681 | 108,783 | 387,459 | 2.1 | 1.7 |
| C. Ex. 8 | 16.8 | 3 | — | 225,249 | 105,769 | 376,839 | 2.1 | 1.7 |
| C. Ex. 9 | 17.2 | 4 | — | 198,900 | 96,600 | 323,100 | 2.1 | 1.6 |
| C. Ex. 11 | 16.9 | 5 | — | 208,200 | 103,200 | 336,800 | 2.0 | 1.6 |
| C. Ex. 15 | 16.9 | — | — | 142,768 | 65,552 | 242,392 | 2.2 | 1.7 |
| C. Ex. 16 | 14.2 | — | — | 144,764 | 67,518 | 246,277 | 2.1 | 1.7 |
| C. Ex. 17 | 13.4 | 21 | — | 140,130 | 66,422 | 230,352 | 2.1 | 1.6 |
| C. Ex. 18 | 14.5 | 19 | — | 138,647 | 63,714 | 233,523 | 2.2 | 1.7 |

### Test Procedures

In all of the foregoing Examples, the Melt Index (MI) measured at 190° C. and 2.16 kg and the MFR measured at 230° C. and 2.16 kg were obtained according to ASTM D1238. The tensile properties were measured according to ASTM D637, and the flexural modulus was measured according to ASTM D790, Procedure B. The Brookfield viscosity was measured using a Brookfield Thermosel viscometer at 190° C., according to ASTM D-3236.

### GPC-4D

Unless otherwise indicated, the distribution and the moments of molecular weight (e.g., Mw, Mn, Mw/Mn) and the comonomer content were determined by using a high temperature Gel Permeation Chromatography (Polymer Char GPC-IR) equipped with a multiple-channel band-filter based Infrared detector IR5, an 18-angle light scattering detector, and a four-capillary viscometer. Three Agilent PLgel 10-μm Mixed-B LS columns were used to provide polymer separation. Aldrich reagent grade 1,2,4-trichlorobenzene (TCB) with 300 ppm antioxidant butylated hydroxytoluene (BHT) was used as the mobile phase. The TCB mixture was filtered through a 0.1-μm Teflon filter and degassed with an online degasser before entering the GPC instrument. The nominal flow rate was 1.0 mL/min, and the nominal injection volume was 200 μL. The whole system including transfer lines, columns, and detectors were contained in ovens maintained at 145° C. The polymer sample was weighed and sealed in a standard vial with heptane flow marker added for flow rate correction. After loading the vial in the autosampler, polymer was dissolved in 8 mL TCB solvent automatically filled into the vial with continuous shaking for about 1 or 2 hrs at 160° C. The polymer concentration at each point in the chromatogram was calculated from the baseline-subtracted IR5 broadband signal intensity multiplied by a mass constant calibrated with polyethylene standards. The mass recovery was calculated from the ratio of the calculated mass, which is corresponding to the integrated area of the concentration chromatography over elution volume, to the injection mass, which is equal to the pre-determined concentration multiplied by injection loop volume. The conventional molecular weight was determined by combining universal calibration relationship with the column calibration, which was performed with a series of monodispersed polystyrene (PS) standards ranging from 700 g/mol to 10,000,000 g/mol. The MW at each elution volume was calculated with Equation (1):

$$log M = \frac{log ( {K}_{PS} / K )}{a + 1} + \frac{{a}_{PS} + 1}{a + 1} log {M}_{PS} \qquad ( 1 )$$

where the variables with subscript “PS” stand for polystyrene while those without a subscript are for the test samples. In this method, α_{PS}=0.67 and K_{PS}=0.000175 while a and K for ethylene-propylene copolymer are calculated from, α=0.695+ (0.01*(wt. fraction propylene)) and K=0.000579-(0.0003502*(wt. fraction propylene). Specifically, α=0.695 and K=0.000579 for ethylene polymers, α=0.705 and K=0.0002288 for propylene polymers. Concentrations are expressed in g/cm³, molecular weight is expressed in g/mole, and K in the Mark-Houwink equation is expressed in dL/g unless otherwise noted.

The comonomer composition was determined by the ratio of the IR5 detector intensity corresponding to CH₃ and CH₂ channels calibrated with a series of PE and PP homo/copolymer standards whose nominal value was predetermined by NMR or FTIR. In particular, this provided the methyls per 1,000 total carbons (CH₃/1000TC) as a function of molecular weight. Since each short-chain branch (SCB) carries one methyl group, the SCB content per 1000TC (SCB/1000TC) is the same as CH₃/1000TC. The weight % propylene was computed as a function of molecular weight from the following expression in which f is 0.3,

$$w 2 = f ⋆ S C B / 1000 TC . \qquad ( 2 )$$

The weight % C2 is then obtained from 100-C3 weight %.

The bulk C2 composition of the polymer was obtained by considering the entire signals of the CH₃ and CH₂ channels between the integration limits of the concentration chromatogram and the bulk SCB/1000TC was converted to bulk w2 in the same manner as described above.

An 18-angle Wyatt Technology High Temperature DAWN HELEOSII was used as the LS detector. The LS molecular weight (M) at each point in the chromatogram was determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c \qquad ( 6 )$$

Here, ΔR(θ) is the measured excess Rayleigh scattering intensity at scattering angle θ, c is the polymer concentration determined from the IR5 analysis, A2 is the second virial coefficient, P(θ) is the form factor for a monodisperse random coil, and Kₒ is the optical constant for the system:

$${K}_{o} = \frac{4 {π}^{2} {{n}^{2} ( dn / dc )}^{2}}{{λ}^{4} {N}_{A}} \qquad ( 7 )$$

where NA is Avogadro's number, and (dn/dc) is the refractive index increment for the system. The refractive index, n=1.500 for TCB at 145° C. and A=665 nm. For the purpose of this disclosure and the claims thereto, dn/dc=0.1048 and A2=0.0015-(0.001*(wt. fraction propylene)) for propylene copolymers.

### SGIC

Solvent Gradient Interactive Chromatography (SGIC) (also referred to as “HPLC-SEC”) analysis was done using an SGIC-2D instrument commercially available from Polymer Char, S. A. of Valencia, Spain. The principles of SGIC-2D analysis are explained in the article Bhati, S. et al. Polyolefins J. 2016, 3, 119. In particular, the schematic configuration shown in FIG. 1(a) of this article is an appropriate depiction of the schematic for the apparatus used in the present case. Pertinent features of the apparatus and relevant details of the analysis method, as they apply to the present case, are as follows.

An IR5 infrared detector commercially available from Polymer Char was used to generate an absorbance signal that is proportional to the concentration of polymer in the eluting flow. The composition signal, in terms of methyl content, was measured as described in the article Ortin, A. et al. Chromatogr. A 2012, 1257, 66. A Hypercarb™ column of dimensions 10.5×100 mm (I.D.×L.) commercially available from Thermo Fisher™ and a stationary phase of porous graphitic carbon (PGC) particles (5 μm, particle size; 138.2 m2/gm, surface area) were used in the first dimension. A PL Rapide H SEC column of dimensions 7.5×150 mm (I.D.×L.) (commercially available from Agilent Technologies) packed with 10 μm particles was used in the second dimension.

The solvents used for preparing the sample solution and for elution were 98+% 1 decanol (decanol) and ≥99% 1,2,4-trichlorobenzene (TCB) as the adsorption- and desorption-promoting mobile phases, respectively; the decanol was used as received whereas the TCB was filtered using a membrane filter commercially available from Omnipore™ (0.1 μm JV). At the beginning of the analysis, the PGC column was flushed and filled with 100 vol % decanol. Temperatures of the PGC and SEC columns were kept at 170 and 160° C., respectively, throughout the analysis. The sample to be analyzed (1-11 mg) was dissolved in 8 ml of decanol (metered at ambient temperature) by shaking (Medium setting) at 160° C. for 90 min. A small volume of the polymer solution was first filtered by an inline filter (stainless steel, 10 μm), which is back-flushed after every filtration. The filtrate was then used to completely fill a 100-μl injection-valve loop. Then the injection valve was switched to let the flow from the gradient pump carry the volume in the loop towards the PGC column, and the switching of the valve coincided with the start of a solvent-gradient profile, shown here as a sequence of time (min), TCB (vol %): 0, 0; 150, 30; 170, 30; 190, 50; 200, 100; 300, 100. Flow rates used for the PGC and SEC columns were set to 0.025 ml/min of mixed solvent (gradient pump) and 3 ml/min of TCB (isocratic pump), respectively, from start to finish of the gradient profile. The transfer-valve loop volume was 100 μl and the valve-switching time was 2 min, thereby filling the loop to 50 μl for each SEC injection and generating 150 SEC chromatograms per sample analyzed.

The data generated was processed using an in-house MATLAB application for setting baselines (for subtraction) and integration limits, calibrating the IR5 detector and SEC column, and calculating all relevant metrics from the processed data. For calibrating the CH₃/CH₂ band ratio of the IR5 detector to obtain the CH₃/1000TC signal, thirty-nine polyolefin samples with CH₃/1000TC in the range of 0-333.3 were used. For calibrating the elution volume from the SEC column to obtain the molecular weight of the eluting polymer, nine narrow polystyrene standards (commercially available from Agilent Technologies) having a peak molecular weight in the range of 1-6035 kg/mol were used.

### Elastic Hysteresis

A Wabash Genesis controlled cooling compression molding press was used to mold a sheet with a final thickness ranging from 8-12 mil (0.2 to 0.3 mm). The press temperature was brought to 180° C. prior to inserting the sample. The sample was allowed to preheat for eight minutes under contact pressure. Compression was then applied for five minutes at 180° C., followed by controlled cooling. From the resulting molded sheet, three specimens were cut with a sharp scalpel blade into strips 150 mm long and 50 mm wide. The specimens were conditioned at 23° C.±2° C. and 50%±10% relative humidity for a minimum of 40 hours before testing.

An Instron tensile tester (InstronR 5566) was used for the elastic hysteresis test. Each specimen was placed in the grips with a 100 mm grip separation. The specimens were stretched to 100% extension at a cross-head speed of 500 mm/min. The crosshead returned to 0% extension and this cycle was repeated once more. Altogether, three specimens were tested per material, and average values for the following elastic properties were reported on a per cycle basis: load at 50% strain, top load, retractive force, load loss, permanent set, and mechanical hysteresis. Load at 50% strain is the force measured on the ascending curve at 50% strain. Top load is the force measured on the ascending curve at 100% strain. Retractive force is the force measured at 50% strain on the descending curve while the specimen is unloading. Load loss is calculated at 50% strain as (Force on Ascending Curve-Force on Descending Curve)/Force on Ascending Curve, taken as a percent. Permanent set is the percent strain corresponding to 0.1 N of force on the descending curve. Mechanical hysteresis is the area enclosed by the ascending and descending curves divided by the total area under the ascending curve, taken as a percent.

### CD Slope

The comonomer distribution is represented as the CD slopes 25, 50, and 75 calculated from the slopes of the comonomer distribution curve estimated at 25%, 50%, and 75% of the highest log molecular weight value, respectively. The slopes were determined by first curve fitting the comonomer content versus molecular weight variation to a nth order polynomial using the MATLAB program. The value of n ranges from 2 and 4. The derivative of the curve was obtained at various molecular weight points, which are 25%, 50%, and 75% respectively, of the range of molecular weight. For example, to determine the 25% point on the x-axis, the difference between the molecular weight minimum (mwmin) and molecular weight maximum (mwmax) for the specific data set was first established. The xvalue of slope 25 was calculated as mwmin+0.25*(mwmax−mwmin). The derivative was determined at that point to find CD slope 25. CD slopes were only calculated between slope 20 and slope 80. A CD slope at any single point between slope 20 and slope 80 is herein referred to as a “CD slope 20 to 80”. Having all CD slope values be in the range of from −1 to 1 was considered to represent a uniform comonomer distribution, whereas having all CD slope values>1.5 was considered to represent a broad orthogonal comonomer distribution (BOCD).

### Listing of Embodiments

This disclosure may further include any one or more of the following non-limiting embodiments:

1. A process for making a propylene-based copolymer, comprising: introducing propylene and at least one other olefin comonomer to a tubular reactor to produce a propylene-based copolymer comprising a broad comonomer distribution, a Mw of about 10 kg/mol to about 2,000 kg/mol, and a MWD of about 2.0 to about 10.0.

2. The process of embodiment 1, wherein the propylene-based copolymer comprises a broad orthogonal comonomer distribution.

3. The process of embodiment 1 or 2, wherein the broad orthogonal comonomer distribution comprises a comonomer distribution (CD) slope 20 to 80 of about 1.5 to about 30.0.

4. The process of embodiments 1 to 3, wherein the tubular reactor comprises one or more tubular reactors, and wherein each of the tubular reactors comprises a recycle pump.

5. The process of embodiment 4, wherein each of the tubular reactors comprises one or more heat exchanger elements.

6. The process of embodiment 5, wherein at least one of the heat exchanger elements is a spiral heat exchanger.

7. The process of embodiment 5, wherein the propylene-based copolymer is produced at a recycle ratio of about 0.1 to about 50.0.

8. The process of embodiment 5, wherein the propylene-based copolymer is produced at a recycle ratio of about 3.0 to about 15.0.

9. The process of embodiment 5, wherein the recycle ratio varies and monomer conversion is constant as the propylene-based copolymer is produced.

10. The process of embodiment 5, wherein the recycle ratio is constant and monomer conversion varies along the axial length of each of the tubular reactors as the propylene-based copolymer is produced.

11. The process of embodiments 1 to 10, wherein the propylene-based copolymer is produced at a cement concentration of about 2 wt % and to about 40 wt %

12. The process of embodiments 1 to 11, further comprising introducing a catalyst system to the tubular reactor.

13. The process of embodiments 1 to 12, wherein the propylene and the at least one other olefin comonomer are copolymerized using a continuous solution polymerization process.

14. The process of embodiments 1 to 13, wherein the at least one other olefin comonomer comprises ethylene, a C4 to C20 olefin, or combinations thereof.

15. The process of embodiments 1 to 14, wherein the propylene-based copolymer comprises a MFR of about 0.1 g/10 min to about 1,000 g/10 min, according to ASTM D1238, or a Brookfield viscosity of about 400 to 50,000 cP, according to ASTM D-3236.

16. A propylene-based copolymer composition, comprising: propylene derived units; and at least one other comonomer derived units, the copolymer composition having a broad comonomer distribution, a Mw of about 10 kg/mol to about 2,000 kg/mol, and a MWD of about 2.0 to about 10.0.

17. The propylene-based copolymer composition of embodiment 16, wherein the copolymer composition has a broad orthogonal comonomer distribution.

18. The propylene-based copolymer composition of embodiment 16 or 17, wherein the broad orthogonal comonomer distribution comprises a comonomer distribution (CD) slope 20 to 80 of about 1.5 to about 30.0.

19. The propylene-based copolymer composition of embodiments 16 to 18, wherein the at least one other olefin comonomer comprises ethylene, a C4 to C20 olefin, or combinations thereof.

20. The propylene-based copolymer composition of embodiments 16 to 19, the copolymer composition having a MFR of about 0.1 g/10 min to about 1,000 g/10 min, according to ASTM D1238 or a Brookfield viscosity of about 400 to 50,000 cP, according to ASTM D-3236.

21. A nonwoven fabric, a film, a plastic tubing, a plastic bag, a cable, or a photovoltaic cell comprising the propylene-based copolymer composition of embodiment 16.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A process for making a propylene-based copolymer, comprising:
introducing propylene and at least one other olefin comonomer to a tubular reactor to produce a propylene-based copolymer comprising a broad comonomer distribution, a MW of about 10 kg/mol to about 2,000 kg/mol, and a MWD of about 2.0 to about 10.0.

2. The process of claim 1, wherein the propylene-based copolymer comprises a broad orthogonal comonomer distribution.

3. The process of claim 1, wherein the broad orthogonal comonomer distribution comprises a comonomer distribution (CD) slope 20 to 80 of about 1.5 to about 30.0.

4. The process of claim 1, wherein the tubular reactor comprises one or more tubular reactors, and wherein each of the tubular reactors comprises a recycle pump.

5. The process of claim 4, wherein each of the tubular reactors comprises one or more heat exchanger elements.

6. The process of claim 5, wherein at least one of the heat exchanger elements is a spiral heat exchanger.

7. The process of claim 5, wherein the propylene-based copolymer is produced at a recycle ratio of about 0.1 to about 50.0.

8. The process of claim 5, wherein the propylene-based copolymer is produced at a recycle ratio of about 3.0 to about 15.0.

9. The process of claim 5, wherein the recycle ratio varies and monomer conversion is constant as the propylene-based copolymer is produced.

10. The process of claim 5, wherein the recycle ratio is constant and monomer conversion varies along the axial length of each of the tubular reactors as the propylene-based copolymer is produced.

11. The process of claim 1, wherein the propylene-based copolymer is produced at a cement concentration of about 2 wt % and to about 40 wt %

12. The process of claim 1, further comprising introducing a catalyst system to the tubular reactor.

13. The process of claim 1, wherein the propylene and the at least one other olefin comonomer are copolymerized using a continuous solution polymerization process.

14. The process of claim 1, wherein the at least one other olefin comonomer comprises ethylene, a C4 to C20 olefin, or combinations thereof.

15. The process of claim 1, wherein the propylene-based copolymer comprises a MFR of about 0.1 g/10 min to about 1,000 g/10 min, according to ASTM D1238, or a Brookfield viscosity of about 400 to 50,000 cP, according to ASTM D-3236.

16. A propylene-based copolymer composition, comprising:
propylene derived units; and
at least one other comonomer derived units, the copolymer composition having a broad comonomer distribution, a MW of about 10 kg/mol to about 2,000 kg/mol, and a MWD of about 2.0 to about 10.0.

17. The propylene-based copolymer composition of claim 16, wherein the copolymer composition has a broad orthogonal comonomer distribution, and wherein the broad orthogonal comonomer distribution comprises a comonomer distribution (CD) slope 20 to 80 of about 1.5 to about 30.0.

18. (canceled)

19. The propylene-based copolymer composition of claim 16, wherein the at least one other olefin comonomer comprises ethylene, a C4 to C20 olefin, or combinations thereof.

20. The propylene-based copolymer composition of claim 16, the copolymer composition having a MFR of about 0.1 g/10 min to about 1,000 g/10 min, according to ASTM D1238 or a Brookfield viscosity of about 400 to 50,000 cP, according to ASTM D-3236.

21. A nonwoven fabric, a film, a plastic tubing, a plastic bag, a cable, or a photovoltaic cell comprising the propylene-based copolymer composition of claim 16.
